(19) United States
(12) Patent Application Publication
(10) Pub. No.: US 2023/0084033 A1
(43) Pub. Date: Mar. 16, 2023

(54) SYSTEM FOR CROWDSOURCING QUESTIONS AND CROWDFUNDING THEIR ANSWERS

(71) Applicant: WEEBID INC., Glendale, CA (US)

(72) Inventor: Gregory Newman Spero, Highland Park, IL (US)

(21) Appl. No.: 17/949,033

(22) Filed: Sep. 20, 2022

Related U.S. Application Data
(63) Continuation of application No. 17/377,199, filed on Jul. 15, 2021, now abandoned.
(60) Provisional application No. 63/053,568, filed on Jul. 18, 2020.

(51) Int. Cl. G06Q 30/06

(52) U.S. Cl. CPC G06Q 30/0621; G06Q 30/0611

(57) ABSTRACT

The inventions described herein relate to the field of online crowdfunding. More specifically, the embodiments described include an online interface for crowdsourcing questions and crowdfunding their answers.

### CROSS-REFERENCE TO RELATED APPLICATIONS

The present application is a continuation of U.S. Pat. Application Serial No. 17/377,199, filed Jul. 15, 2021, which claims priority to U.S. Provisional Application Serial No. 63/053,568, filed Jul. 18, 2020, both of which are hereby expressly incorporated by reference in their entireties for all purposes.

### FIELD OF INVENTION

The subject matter described herein relates to the field of online crowdfunding. More specifically, the embodiments described include an online interface for crowdsourcing questions and crowdfunding their answers.

### BACKGROUND

Applications exist that allow an influencer to offer something to his/her fanbase at a cost determined by the collective bid of the fanbase. In these applications, the individual selling a product or service to the fanbase is usually the one initiating the process, describing a product or service to then be funded collectively by the people who want to receive that product or service in exchange for money. The individual selling the product or service usually creates a page which takes time and attention, and the individuals who would consider purchasing the product or service then view the page, share with the page with friends, and bid varying amounts on the item in exchange for varying rewards associated with the item. Existing crowdfunding platforms are deficient since they only allow for campaigns to be created by the seller of an item, and not by a buyer of an item. This does not create a system in which Buyers can collectively influence the actions taken by Sellers to create or perform something that the Buyers want; it only offers a way for Buyers to sign up for things Sellers are already offering and want to sell. Crowdfunding applications like Kickstarter are also used primarily to raise funds in order to create a product or service, resulting in a longer series of interactions between the person holding the campaign who is proposing the product or service and the people who are bidding on the campaign. This transaction is generally a payment for the promise of something identified by the seller that will then be delivered at a future date.

The process used by Kickstarter and other existing crowdfunding applications works when a Seller already has a good idea of what the Buyers want, but the time and attention required by both the Seller and the Buyers makes it likely that the Seller will only create one or a very few offerings of what he/she thinks the Buyers will want during any reasonable period of time, and the Sellers’ decision of what to offer is not immediately informed by the Buyers except for potentially in separate field-testing and research outside this process. This process executes the so-called “crowdfunding” model to purchase what is being offered by the seller, but does not rely on the crowd to determine which products or services should be offered by the Seller in the first place. Popular examples of this crowdfunding include Kickstarter and Indiegogo.

In other applications, users are able to submit questions to influencers, other users, and general questions with an unspecified recipient, and see the other users’ questions, and ‘upvote’ the questions in which they are interested. This results in any user being able to easily see what the most popular/relevant question is. Versions of this model exist in applications such as Quora, Reddit, and the comments section of any given video on YouTube. These systems do not allow for users to bid money on answers to questions, and do not create any opportunity for collective offerings to be made for a total sum in exchange for the question being answered or request being executed or performed. Users can say something like “I really want Kanye West to do a song with Taylor Swift” but the question’s existence has little-to-no impact on whether Kanye and Taylor will create the song, because there is no tangible reward that can be effectively and efficiently offered in exchange for their delivery of the song, and because the question becomes insignificant in a system that is more geared towards general conversation than it is geared towards the curation of ideas for the purpose of execution by specific individuals or entities.

Thus, needs exist for a platform or system in that the Seller is more likely to deliver an Answer the Buyers are specifically requesting. Needs also exist to combine these functionalities described above, allowing Buyers to individually or collectively submit questions and requests, allowing Buyers to collectively make monetary offerings to incentivize potential answers and responses to those individual questions, without requiring oversight from the Seller who will be answering the question. By combining these functionalities, for the first time, the crowd is enabled to collectively make offers to individuals to answer certain questions and requests while removing barriers, creating an efficient new marketplace for promoting the exchange of ideas, actions, products, services and information.

Furthermore, needs also exist for a system with this combination of crowdsourcing questions and crowdfunding answers and a marketplace for new products and ideas, whether they be videos shot, songs created, recipes written, actions taken in the real world, products created, or anything else that an individual or group could be paid to do.

### SUMMARY

The inventions described herein relate to the field of online crowdfunding. More specifically, the embodiments described include an online interface for crowdsourcing questions and crowdfunding their answers.

Generally, the present invention may include a system that enables one or more Buyers to create questions or requests of individuals or entities (Sellers), bid collectively (as a crowd) for the answers or responses to these requests, allowing Sellers to deliver upon those requests in exchange for the collective bid of the Buyers. The disclosed processes are just exemplary of the present invention and represent some of the many ways in which the invention can be modeled.

In some embodiments, the present invention may include a system and interface that allow an individual (or an entity, for example, a corporation, a non-profit, organization, government, any group, or any individual, which will herein be referred to as ‘Buyer’) or multiple Buyers to submit questions or requests (herein called ‘Questions’) to another individual or entity (including corporation, non-profit, organization, government, any group, or any individual, which will herein be referred to as ‘Seller’). It then allows the Buyer as well as other Buyers to bid amounts (e.g., micropayments) on the question or request, which compile to a sum total. The sum total is then available as an exchange to the Seller if the Seller creates and delivers an answer or response to the question. The answer or response (herein called “Answer”) can be in the form of text, video, photo, PDF, audio file, product, service, an action taken (e.g., performance, etc.) outside an interface, or anything that the Buyer might request from the Seller. An Answer may include ideas, actions, products, services and information.

In some embodiments, the system may enable Buyers who would provide offering payments (e.g., micropayments or otherwise) to another individual in exchange for Answers to Questions. Questions are directed towards individuals who might consider delivering a product, service, action, information, etc. requested by the Buyer. It may allow Buyers to place a monetary bid on their Question, and allow them to see other Buyers’ Questions, and also bid on those. The invention may allow Sellers to view Questions posed to them, and Answer those Questions in exchange for the combined bid of all Buyers who place bids. The invention may deliver the Answer or responses in the form of video, audio, text, image, product, service, or any other item or act serving as proof that the question or request has been executed, confirms using Buyer feedback that the request was in fact delivered, and once that has been confirmed, deposits the money from the many Buyers into the account of the Seller.

In some embodiments, Buyers can also create requests of multiple sellers simultaneously. This would be the case if, for example, a fan of Kanye West and Taylor Swift wanted to see them do a song together. The Buyer would create a Question such as “Collaborative recording between Kanye West and Taylor Swift” and direct it towards both Kanye West and Taylor Swift as Sellers. Once the request is placed, other Buyers can bid any amount, adding their amount to the total bid offered to Kanye and Taylor to perform together. Once Kanye and Taylor create and record a song together, and deliver it to the Buyers, the collective bid from all Buyers will be delivered, for example equally (50/50), to the accounts of the Sellers. Sellers can also negotiate and change the percentage split between each other before the Answer (in this case, the song) is delivered.

### Answering a Question, and Verifying an Answer Using Buyer Feedback

The process of exchanging the collective Bid from all Buyers for the Answer from the Seller is one aspect of a preferred process of the present invention. As one example, this process may be executed in the following steps:
1) Seller submits an answer to the preferred interface via a mobile app or web app.
2) Once Seller submits an Answer, the Bids from all Buyers are locked, and cannot be modified.
3) The Answer is delivered to the Buyers who have Bid on the Question for a limited time frame (e.g., 24 hours)
4) During this timeframe, Buyers may view the Answer in full. Upon receiving access to the Answer, the Buyer will have the option to Accept or Decline the Answer.
5) If the Buyer Accepts the Answer, the Buyer may continue to view the Answer for the remainder of the time frame (e.g., 24-hour period). If the Buyer Declines the Answer, the Buyer is no longer able to access the Answer.
6) At the end of the time frame (e.g., 24-hour period), the ratio of Accepts to Declines is analyzed against the percentage that is most likely to determine the genuine viability of the Answer to the Buyers (e.g., 50%). If the ratio is above that percentage (e.g., 51% or more) at the end of the time frame (e.g., 24-hour period), then the Answer is made permanently available to all Buyers who Bid on the question, and available publicly to all users. At the same time, all Bid amounts from Buyers which were Bid on the Question are transferred from the account of each Buyer to the account of the Seller who submitted the Answer. If the ratio is below that percentage (e.g. 49%) at the end of the time frame (e.g., 24-hour period), then the Answer is removed from all Buyer accounts, and not made public to any users. At the same time, the Bids from all Buyers who Bid on the Question are unlocked, and the Buyers may use those funds freely in their Accounts. At the same time, the Seller is notified that the Crowd did not accept his/her Answer, and he/she may resubmit another answer for consideration by the Buyers. If the Seller submits another Answer, the new Answer goes through the same verification process as the previously submitted Answer, allowing Buyers to collectively determine if the new Answer is acceptable.

### Answers Can Apply to Multiple Questions

In some embodiments, within the context of a system where Buyers can ask as many questions as they can think of, and add Bids to any of these questions, it is inevitable that multiple questions will arise that justify the same or a similar Answer from a Seller. The preferred system includes two methods to solve problems created by this redundancy.
1) The preferred system may use artificial intelligence and human oversight to monitor questions that may call for an obvious unified answer. For example, if one Buyer submits a question to Kanye West that asks “Make a biopic,” and another Buyer submits the question “Create a movie about your life,” these two questions may both be answered by a single submission by Kanye West of a movie about his life. The administrative system will catch and unify these questions using the following method.
   a) Language recognition software will scan each question, and notify human administrators, via the admin system, of all questions that may have similar meaning and justify a similar outcome. It will list the questions for the human administrator to view in the order of value, from the question with the highest aggregate Bid to the question with the lowest Aggregate bid, and in alphabetical order in cases in which the aggregate Bid is the same.
   b) Human administrators will review these questions. The system will allow the human administrators to select Questions that are similar and select a Question that is most likely to represent all the selected questions the most accurately. The administrator will then click “combine” and it will combine all the followers, Bids, and Questions into one question, which will be represented by the language of the Question that was selected to be the most indicative of all the Questions. (When the Question is selected, the system may or may not allow Buyers and Sellers to view a list of all Questions that were combined under the final remaining Question.)
2) When a Buyer submits an Answer, the Buyer can select multiple Questions to be answered by a singular Answer. These questions will be treated as though the singular Answer was submitted to each Question individually, allowing the Buyers who Bid on each individual Question to dictate whether or not the Answer is accepted for the particular Question on which they Bid, using the Buyer Feedback process described herein. The acceptance of the Answer for each Question will depend solely on the Buyer Feedback of that particular Question, and the answer will be accepted or rejected accordingly.

### Seller Verification

In some embodiments, the preferred system may aggregate questions from many Buyers directed towards Sellers who have not yet registered to be a part of system. One aspect includes a process that determines whether or not the Seller is actually the person to whom the Questions are being asked. The preferred system will determine that each Seller entering the system is that person by implementing, for example, the following process:
1) Buyers are able to enter any Name in the field to whom they Ask a Question (“Name” refers to the text entered by a Buyer in the field designated for the identification of the Seller when the Buyer is submitting a question).
2) When multiple questions are submitted with the same Name, the database associates those question with the same singular field for that Name
3) A Seller will be able to Claim that a Name is, in fact, his/her Name, through the following methods:
   Clicking on a Name on a Bid Card and selecting “I am this person”
   Submitting a Claim through the website, app, or support line that he/she is the Name to whom the people are asking questions on the preferred system.
4) Upon submitting a Claim, the Seller will go through a verification process consisting multiple steps. The following is an example of what that set of steps could be:
   Submit driver’s license for verification
   Submit passport for verification
   Connect a Facebook Fan Page for verification
   Connect a verified Twitter account for verification
   Connect a verified Instagram account for verification
   Embed a piece of code into the Seller’s official website for verification
   Meet a WeeBID representitive in person for verification
5) Once a Seller is Verified to be the Name in the system that correlates with Questions to that Name, the Seller will be able to answer any Questions that have been posed to that Name up to that point, and all Questions posed to that Name thereafter.
6) If the preferred system has reason to believe that a Verified Seller is not actually that Seller, or that a Seller’s account has been compromised, the Seller’s access to all Questions will be frozen until the system is able to verify that the Seller is that person.

### Universal Questions

In some embodiments, another preferred process is the ability for Buyers to ask Questions that can be answered by any Seller that is able to Answer the Question sufficiently to the Buyers. This process may be executed in multiple steps. The following is an example of what those steps could be:
1) A Buyer selects “anyone can answer this question” when submitting a Question and does not specify any specific Seller.
2) The Question is made available for Bidding by other Buyers with the same method as normal Questions.
3) Any User, including both Buyers and Sellers, can submit an Answer to the Question.
4) When an Answer is submitted, the Answer is sent to all Buyers who have Bid on the Question.
5) Upon receiving the Answer, the Buyers who have Bid on the Question have the option to Accept or Reject the answer. An amount of time goes by before the Accept and Reject ratio is calculated. This amount of time is determined by a calculation that includes the total amount of Accepts and Rejects that have been submitted along with the amount of time other Questions have taken to accurately determine the viability of an Answer.
6) After this amount of time passes, the Accept to Reject ratio is determined. If this ratio is greater than a number determined to accurately represent the crowd’s acceptance of an answer, the Answer is accepted, and the Answer is made publicly available to all Users, including the Buyers who Bid on the Question. If the ratio of Accepts to Rejects is less than the number determined to accurately represent the crowd’s acceptance of an Answer, the Answer is rejected, and it is made unavailable to all users except the Seller who initially Submitted the Answer.
7) If the Answer is Accepted, the Question is closed. If the Answer is Rejected, the Question remains open, and another Seller is able to Submit an Answer to the Buyers who Bid on the Question. This Answer will go through the same Acceptance/Rejection process to determine if it is Acceptable to the Buyers who Bid on the Question.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

Further, other systems, devices, methods, features and advantages of the subject matter described herein will be or will become apparent to one with skill in the art upon examination of the following figures and detailed description. It is intended that all such additional systems, devices, methods, features, and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 shows an exemplary interface in accordance with a preferred embodiment of the present invention.

FIG. 1a shows a preferred system diagram.

FIG. 2 shows an exemplary interface in accordance with a preferred embodiment of the present invention.

FIG. 3 shows an exemplary interface in accordance with a preferred embodiment of the present invention.

FIG. 4 shows an exemplary interface in accordance with a preferred embodiment of the present invention.

FIG. 5 shows an exemplary interface in accordance with a preferred embodiment of the present invention.

FIG. 6 shows an exemplary interface in accordance with a preferred embodiment of the present invention.

FIG. 7 shows an exemplary interface in accordance with a preferred embodiment of the present invention.

FIG. 8 shows an exemplary interface in accordance with a preferred embodiment of the present invention.

FIG. 9 shows an exemplary interface in accordance with a preferred embodiment of the present invention.

FIG. 10 shows an exemplary interface in accordance with a preferred embodiment of the present invention.

FIG. 11 shows an exemplary interface in accordance with a preferred embodiment of the present invention.

FIG. 12 shows an exemplary interface in accordance with a preferred embodiment of the present invention.

FIG. 13 shows an exemplary interface in accordance with a preferred embodiment of the present invention.

FIG. 14 shows an exemplary interface in accordance with a preferred embodiment of the present invention.

FIG. 15 shows an exemplary interface in accordance with a preferred embodiment of the present invention.

FIG. 16 shows an exemplary interface in accordance with a preferred embodiment of the present invention.

FIG. 17 shows an exemplary interface in accordance with a preferred embodiment of the present invention.

FIG. 18 shows an exemplary interface in accordance with a preferred embodiment of the present invention.

FIG. 19 shows an exemplary interface in accordance with a preferred embodiment of the present invention.

FIG. 20 shows an exemplary interface in accordance with a preferred embodiment of the present invention.

FIG. 21 shows an exemplary interface in accordance with a preferred embodiment of the present invention.

FIG. 22 shows an exemplary interface in accordance with a preferred embodiment of the present invention.

FIG. 23 shows an exemplary interface in accordance with a preferred embodiment of the present invention.

FIG. 24 shows an exemplary interface in accordance with a preferred embodiment of the present invention.

FIG. 25 shows an exemplary interface in accordance with a preferred embodiment of the present invention.

FIG. 26 shows an exemplary interface in accordance with a preferred embodiment of the present invention.

FIG. 27 shows an exemplary interface in accordance with a preferred embodiment of the present invention.

FIG. 28 shows a flow diagram in accordance with a preferred embodiment of the present invention.

FIG. 29 shows a flow diagram in accordance with a preferred embodiment of the present invention.

FIG. 30 shows a flow diagram in accordance with a preferred embodiment of the present invention.

FIG. 31 shows a flow diagram in accordance with a preferred embodiment of the present invention.

FIG. 32 shows a flow diagram in accordance with a preferred embodiment of the present invention.

FIG. 33 shows a flow diagram in accordance with a preferred embodiment of the present invention.

FIG. 34 shows a flow diagram in accordance with a preferred embodiment of the present invention.

FIG. 35 shows a flow diagram in accordance with a preferred embodiment of the present invention.

FIG. 36 shows a flow diagram in accordance with a preferred embodiment of the present invention.

FIG. 37 shows a flow diagram in accordance with a preferred embodiment of the present invention.

FIG. 38 shows a flow diagram in accordance with a preferred embodiment of the present invention.

FIG. 39 shows a system diagram in accordance with a preferred embodiment of the present invention.

### DETAILED DESCRIPTION

The following detailed description describes the present embodiments with reference to the drawings. The disclosed drawings represent a specific manifestation of the invention which can be modeled in various other ways and is only one example of the possibility in which the invention can be built. In the drawings, reference numbers label the present embodiments. These reference numbers are reproduced below in connection with the discussion of the corresponding drawing features.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

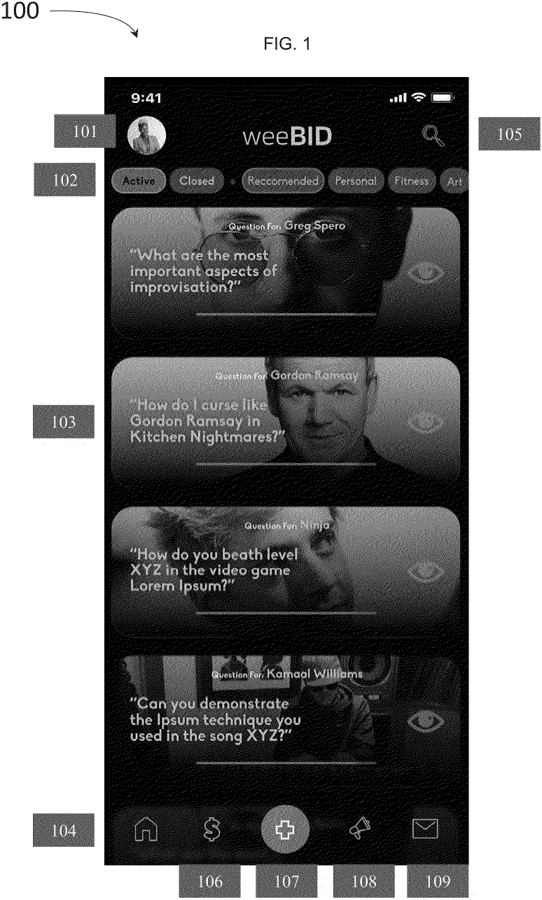

FIG. 1a shows a computer-based system 10 that provides an interface for crowdsourcing questions and crowdfunding their answers according to an embodiment of the present invention. The system 10 generally includes a server system to provide the crowdsourcing and crowdfunding 12, which may be distributed on one or more physical servers, each having one or more processors, memory, an operating system, and input/output interfaces, and a network interface all known in the art, and a plurality of end user devices 14 and 15 coupled to a network 18, such as the Internet and/or a cellular-based wireless network, a private network, or a combination thereof. The user devices 14 and 15 include, for example, mobile device, desktop, smart TV, and so on. A mobile device 15 may be a mobile phone, a tablet, a laptop, a wearable device, or any portable device having a network interface known in the art. A user device 14 may be any combination of devices. A user device 14 may run one or more applications, such as Internet browsers, voice calls, video games, videoconferencing, and email, among others.

Turning to FIG. 1, an exemplary interface 100 of the invention’s Buyer Home Page from the prospective of the Buyer is shown. Interface 100 as well as the other interfaces described herein are implemented as an application on a mobile device 15 but can also be implemented as a customized webpage or any other electronic interfaces known in the art on any user device 14. Interface 100 is communicatively coupled to the backend server system 12 per FIG. 1a. Interface 100 includes a Buyer profile image 101, making it clear to the Buyer that this is his/her home page. Further included are ‘Tags’ 102 associated with each individual bid card. One important distinguishing factor between bid cards is whether they are active or closed. Active bid cards represent questions that have not yet been answered. Closed bid cards represent the answer to a question that has been closed and delivered. Active bids are selected by default, showing the user only questions on which other Buyers are still bidding, and on which the Buyer still has the opportunity to bid or adjust his/her bid. To the right of the active/closed Tag selector, the user can select from other Tags that will help the Buyer browse through existing questions that he/she may find interesting. The default Tag is ‘recommended,’ which will use an algorithm and user data to determine what is most likely to be of interest to the user. Other Tags that can be selected are categories such as ‘personal’, ‘fitness’, ‘arts’, ‘music’, and even more granular Tags such as ‘concerts’, ‘techno’, etc. Relevant Tags will be determined by user data and which Tags are associated with items that the user is already watching or bidding upon.

One tag is “New” (not shown) which, when selected, will activate the display of the newest most relevant bids to that user, refreshing on a moment-to-moment basis (as quickly as one additional Bid Card shown every second). The older Bid Cards will be pushed own horizontally below the new ones, which will appear at the top of the Bid Cards section of the Buyer Home Page.

Interface 100 also includes a ‘Bid Card’ 103. The Bid Card 103 is created when a Buyer creates a question for a Seller and represents that unanswered question. This question may be a request for information or for a particular product or for an idea to be executed by a seller. The buyer may be a fan of a particular artist and said artist may be the seller to execute said request. It contains the basic data relevant to a Buyer, including the question, the name of the Seller to whom the question is directed, the current total amount of money currently bid on the question, and the bid amount (if any) that the buyer has placed on the question. Once a Seller becomes aware that a question is asked to him/her, he/she has the option to set a Goal. The Goal represents the total bid amount at which the Seller would be willing to answer the Question. This amount is relayed to Buyers via the Goal number on a bid card. As shown, Bid cards are stacked vertically on the Buyer’s home page, and the Buyer can scroll down through an infinite number of bid cards.

Interface 100 also includes a main menu 104 that remains available throughout all pages of the application. It contains the home button, which takes you to the page currently displayed in this image, and also contains buttons to navigate to the ‘My Bids’ page 106, the ‘Ask A Question’ page 107, the ‘Answers’ page 108, and the ‘Messages’ page 109. Further included is a ‘Search’ button 105. When a user presses the Search button 105, a text box appears below Tags 102 in which the user can enter search text (not shown). Entering text in this box, the user can search for relevant questions, answers, Buyers, Sellers, Tags, and other information that can be found in the system.

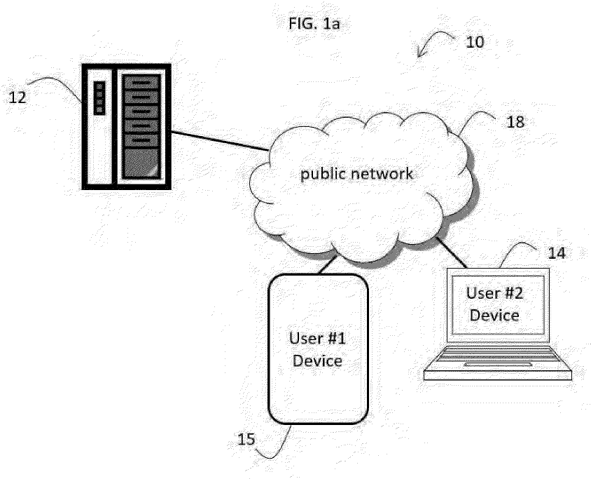

FIG. 2 shows an interface 200 that displays exemplary ‘Answer Cards’ 201, each of which represents an answer given by a Seller in response to a Buyer’s Question in exchange for the total bid on that question. The most relevant Answer Cards are displayed by default when the Closed button 202 is pressed. “Closed” refers to Closed Bids, representing bids that have been closed because the Seller has successfully delivered the answer to the question. This is as opposed to “Active” bids on which Buyers can still bid, because the bidding on that particular question has not yet been closed.

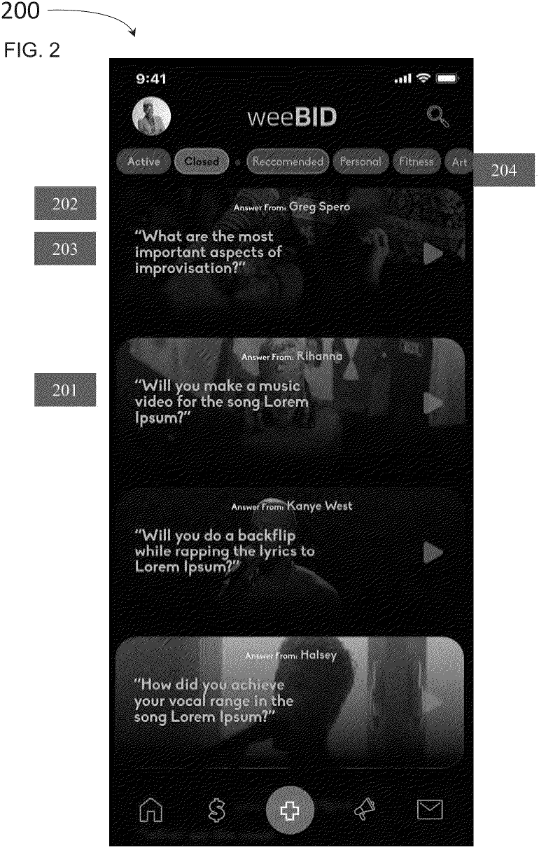

Buyers can click on an Answer Card 201 to view the Answer to any Question on the system. Answer Cards can be scrolled through vertically and filtered based on selected tags 204 similarly to Bid Cards. When the Buyer selects any individual Answer Card, the Buyer is redirected to the home page of the Seller who created the Answer (see FIG. 3), where the Answer to the selected Question will be automatically displayed at the top of the page 301, and additional relevant Answers from that Seller will be displayed below the selected Answer 302 along with other relevant information about the Seller.

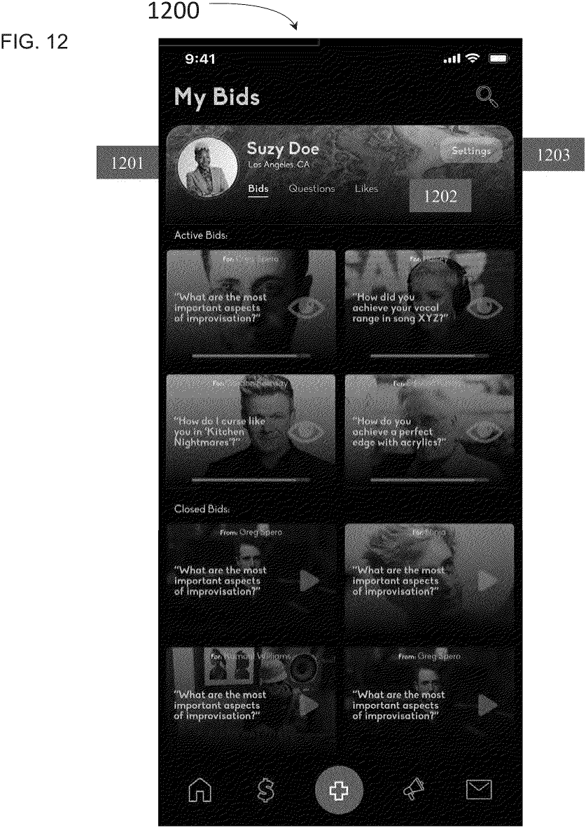

Turning to FIG. 3 shows an exemplary Answer Card user interface 300 when it is expanded/selected by the user. The main section of this page consists of the media that has been submitted by the Seller to answer the Question 301. The card 300 also displays the fact that the content represents an Answer by showing the word “Answer” in the top left corner, followed by the question being answered 305. The Profile Pic of the seller appears in the upper right corner of the answer card 306. When clicked, this profile pic takes the Buyer to the Seller Profile Page (see FIG. 13). The thumbnails below represent additional related answers which will appear based on their relevance to the Buyer viewing the page 302. Buyers will also be able to search for other relevant answers from the Seller in question using the Search button 304 and scroll downwards to see additional answers that may be relevant to the Buyer. Users can Save, Comment on, Love, Subscribe, and Share any Answer 303. When a Buyer presses Save on an Answer Card, the Answer will be stored in a playlist labeled “Saved Videos” which can be accessed via the Buyer’s Home Page 100.

When a Buyer presses Comment 303 on an Answer Card 300, a text field will appear in which the Buyer can leave a public comment on the Answer. These comments will be made viewable by clicking on the Answer card for more detail. Additional details that will appear include the Total Number of Views, Total Comments, Final Bid Amount, Goal Amount, and other relevant information. When a Buyer presses Love button 303 on an Answer Card interface 300, the number of “Loves” displayed publicly on the answer card will increase by one, and the “love” button will become filled in when viewed by the Buyer in question. The “Loves” number represents the total number of people who pressed “Love” on that particular Answer Card. When a Buyer presses “Subscribe” button 303 on an Answer Card interface 300, the buyer will become subscribed to that Seller’s channel. The Buyer will then be informed when a new question for that Seller is trending among Buyers, and when the Seller submits another Answer to a Question. When a Buyer presses “Spread” 303, he/she will have the option to share on their Profile Page, their story, or share to facebook, instagram, twitter, or copy a link to the Answer Card.

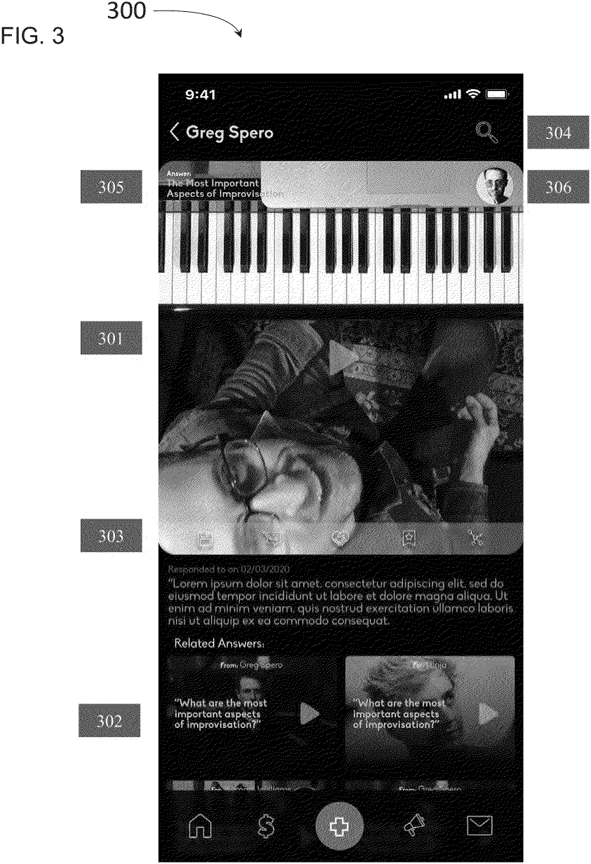

Turning to FIG. 4, an exemplary interface that will give Buyer information about the collective bid on each question 400 is shown, which allows Buyer to place a bid on the question. When a Buyer presses the ‘Raise’ button 401, his/her bid increases by a small amount of money. This amount of money is then added to the ‘Current Total’ 402, further incentivizing the Seller to answer the question. When a Buyer presses the ‘Lower’ button 405, the user’s bid decreases by a small amount of money, down to a minimum of zero dollars. The total amount of the individual Buyer’s bid is displayed in the lower center of the Bid Card 406. The ‘Goal’ 403 represents the monetary amount that the Seller has promised would represent the tipping point at which he/she would submit an Answer to the Question. The Goal can be set by a user once he/she discovers that a question is posed to him/her in the interface. Once the Seller discovers a question to which he/she wants to create a Goal, he/she will go through the following exemplary process in order to claim that question and set a goal:
(1) Create a Seller account in system described herein.
(2) Submit a claim that he/she is the Seller being represented by the question
(3) Go through an identity verification process submitting relevant documents such as a driver’s license or passport

After going through the above three steps (or more, depending on security protocol decisions), the Seller can set a goal to represent the tipping point at which he/she will answer a question. Once the Seller has gone through the verification process, it will be simple and easy for the Seller to answer the question whenever they choose, collect the collective crowd payment for their answer, and deposit that money into Seller’s bank account.

An exemplary process for sellers receiving funds may be as follows:
(1) Seller submits answer to question, and buyers receive the answer. At the same time, funds from Buyers are all locked and non-refundable during the verification process. This answer can be in the form of a video or audio message or may include a link or image that proves that the request has been completed, e.g., in the case of an idea to be executed.
(2) Some level of verification feedback is aggregated from the users who bid on the question, and the answer is determined to be at a reasonable level of satisfaction to the Buyers.
(3) Funds are transferred to the Seller’s account, and the answer is made permanently available to all Buyers in the application.
(4) The seller has the option to withdraw funds at any time from their account to a bank account. Seller can also use these funds to bid on other questions as a Buyer.
   Users can do the following to bid cards 407, to the right in this order:
   ‘Save’ for future reference, and add to a ‘Bid List’ of their choice
   ‘Comment’ and interact with other users’ comments
   ‘Love’ which will add the question to the user’s ‘favorites’ list
   ‘Subscribe’ to the bid channel of the Seller who is being asked the Question

‘Share’ the bid card on their user home page within the present system, and/or with other social media platforms such as Facebook, Instagram, and Twitter.

Bid Cards 100 are either stacked vertically and scrollable so users can browse through other related bid cards, or minimized to smaller representations of the bid cards 100 that can be stacked both vertically infinitely and horizontally two across.

The Bid Card 100 represents a unique correlation derived from data within the system. This correlation is between the total amount bid on a question, and the total amount of “likes” (or “loves”) given by the collective userbase. The correlation between these two numbers allows us to derive a precise estimated ratio of monetary value to attention of any given idea. For example, if a buyer asked Kanye West to create a song about Twinkies through the present system, and the total Bid amount is $1,000,000, and that same question has 10,000 ,000 likes, we will know that the monetary value of each individual like is approximately $0.10. If that same question only had 1000 likes, then the monetary value of each like would be $1000. This has major implications and widespread applications in marketing, as it can inform which ideas have the most value and are worth marketing above other ideas.

The Value Per Like (or VPL) is a proprietary metric derived from the unique style of data aggregation and correlation within the system.

VPL: Value Per Like
VPL = Total Question Payout / # of Likes

Another unique metric found in the system is Average Bid Value (ABV). This is derived from the total amount bid on any given question divided by the number of bids on the question.

ABV: Average Bid Value
ABV = Total Question Payout / # of Bids

Value Per Engagement (VPE) is derived from a combination of VPL and ABV.

VPE: Value Per Engagement
VPE = Total Question Payout / (# of Likes + # of Bids)

Another unique metric is Value Per Impression (VPI). This is the total amount bid on an item divided by the total number of times that question has been seen within the system. VPI will be the number most important to marketers determining whether or not to spend money to advertise any given question. If the cost per impression of any given advertiser is lower than the VPI, it will make sense for a marketer to spend money procuring new impressions.

VPI: Value Per Impression
VPI = Total Question Payout / # of views

Other Marketing metrics include:

CPM: Cost Per Mille (Cost per thousand impressions)
CPC: Cost Per Click
CTR: Click Through Rate
CPA: Cost Per Action

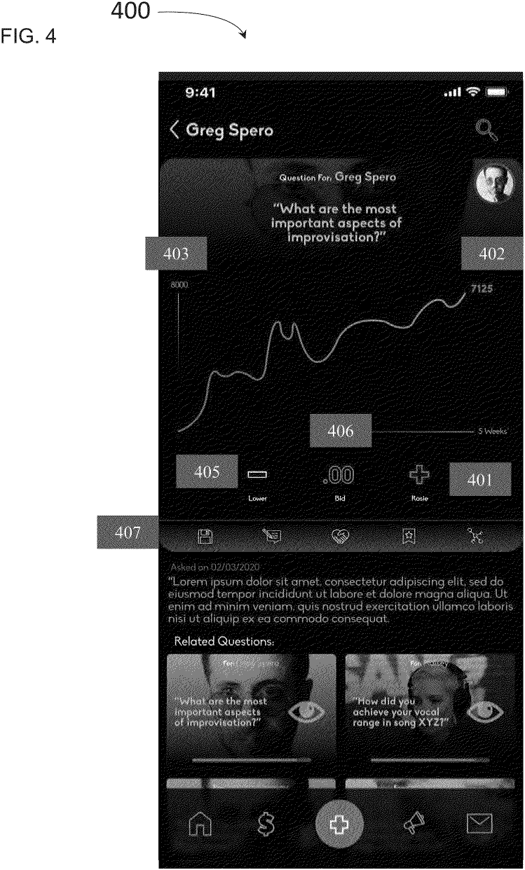

FIG. 5 shows an exemplary interface 500 with which a Seller submits an Answer to a Question. This page displays at least the following exemplary information:
Buyer who asked the question 507
The Question to be answered 508
Expected reach, representing the total amount of people expected to view the answer 509. This is a valuable metric which will help motivate the Seller to answer the question, when combined with the motivation from the Gross Expected Payout.
Corporate Endorsement 510. This represents the total amount pledged by a Corporate Sponsor in exchange for inclusion of the Sponsor’s brand in the Seller’s Answer. Corporations will be able to browse through relevant and popular questions, and offer relatively large Bids with a proposal detailing what the Seller will be expected to do in exchange for that Bid. If the Seller accepts the Corporation’s Bid, it will be considered an Endorsement, and the Seller will be expected to follow through with the requests of the Corporation for inclusion of their brand in the Seller’s answer. For this inclusion, the additional amount of Corporate Endorsement will be added to the Gross Expected Payout, and delivered upon successful submission of the Seller’s Answer.)
Gross Expected Payout 511 represents the sum total of Buyer bids and Corporate Endorsement. This is the amount that the Seller will earn by answering the question. The Gross Expected Payout will fluctuate in real time based on the amount of bids submitted and retracted by Buyers, and the level of Corporate Endorsement offered.

The Seller can submit a video by pressing the record button and recording a video answer directly into the interface 500. The Seller can also answer the question via audio recording, file upload, and a number of other ways.

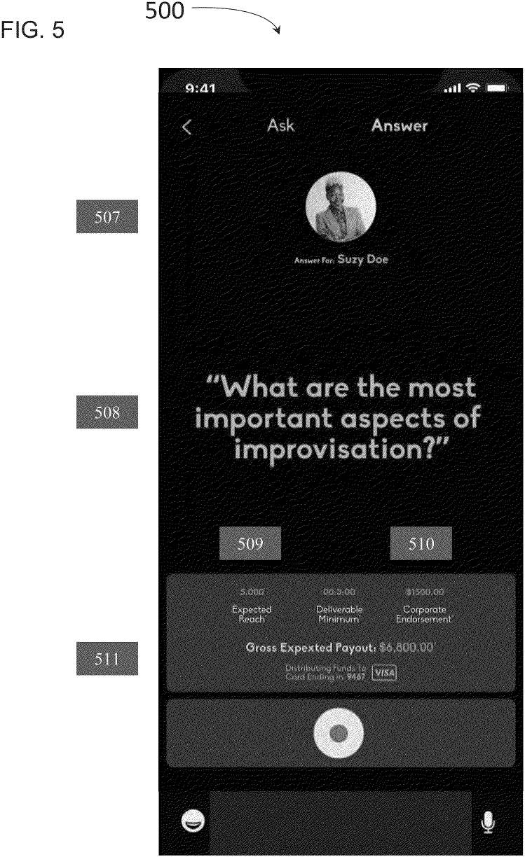

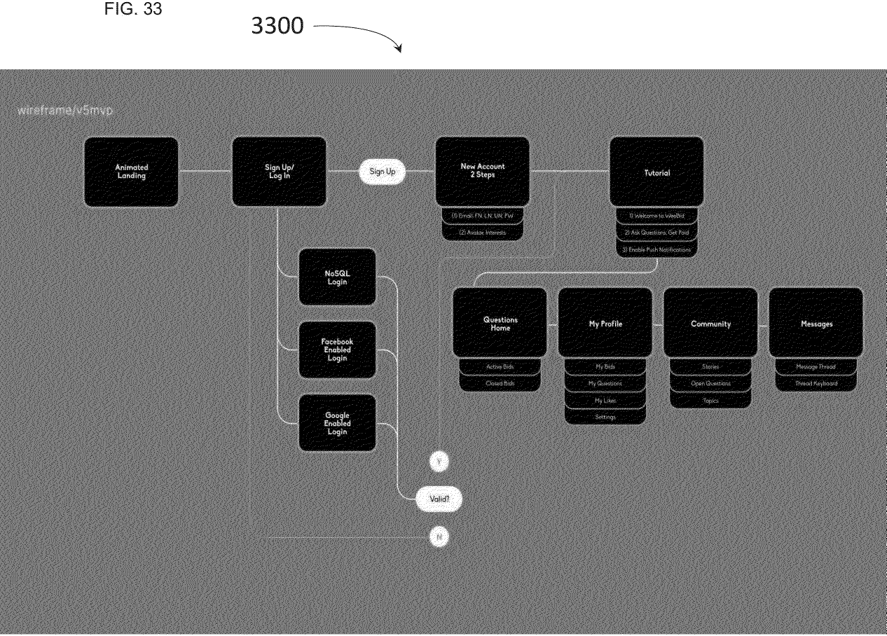

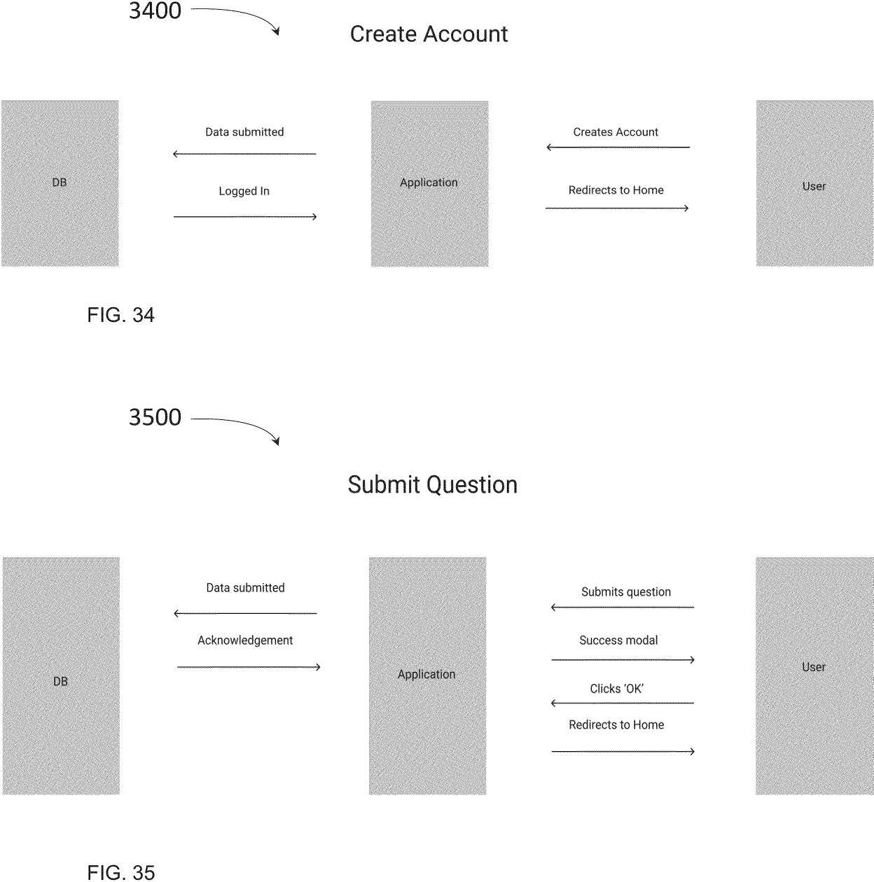

FIG. 6 shows an exemplary Question Submit interface 600. This is the interface 600 through which a Buyer can create a question for a Seller. The seller to whom the question is being asked is shown 601. When clicked, this icon 601 becomes a blank text field, and the Buyer can input any name he/she chooses. If the seller is registered in the system, or if other buyers have submitted to that same Seller even if he/she is not registered, the field will pre-populate with the completed name of the seller as the Buyer types the name. If the Seller is does not exist in the database, DB, (described below, e.g, FIGS. 34 and 35) located at server system 12, the Buyer will still be able to submit that Seller’s name as the recipient of the Question, and the database DB, (described below, e.g, FIGS. 34 and 35), will add that Seller’s name to the list of names that will be used to pre-populate the Seller name when other Buyers are selecting Sellers to whom to ask questions.

The Buyer may type his/her question in 602. This field may be limited to 200 characters and may represent the question that the Seller may have to answer in exchange for the collective bid from the Buyers.

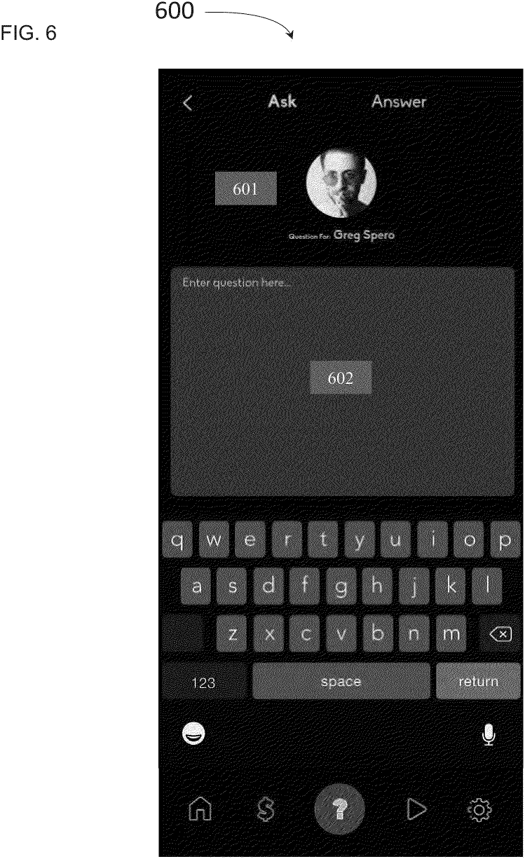

FIG. 7 shows an exemplary search interface 700. Users will enter keywords 702 which will then be correlated with questions, answers, people, categories, and tags. The first search to appear will be an estimate of the most likely result based on a search of all these categories as it relates to the Buyer’s input. The Buyer will then have the option to distill the results further by selecting to show the results of the search terms as they relate to Questions, Answers, People, or Categories 701, (from left to right). Results will appear cascading as Bid Cards 100, Answer Cards 200, profile links, or links to community categories, below the search input box 703.

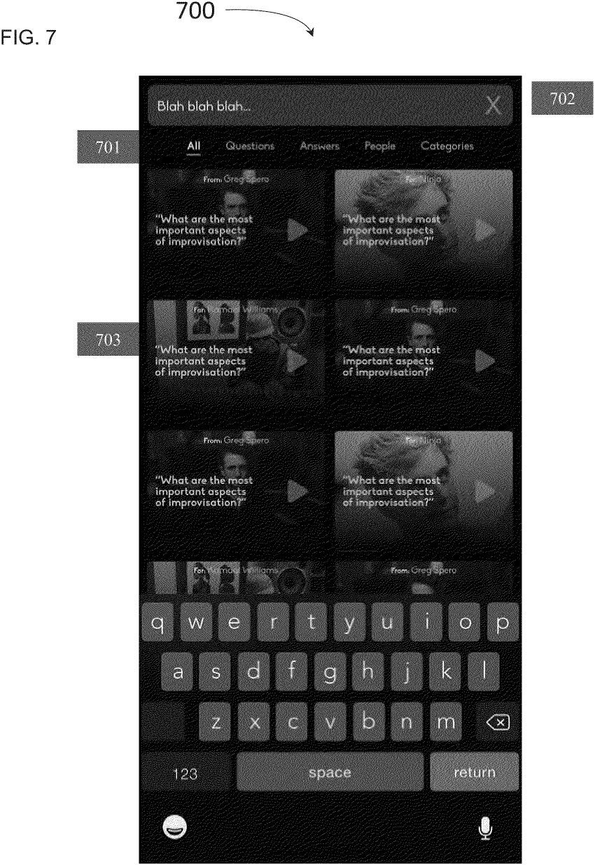

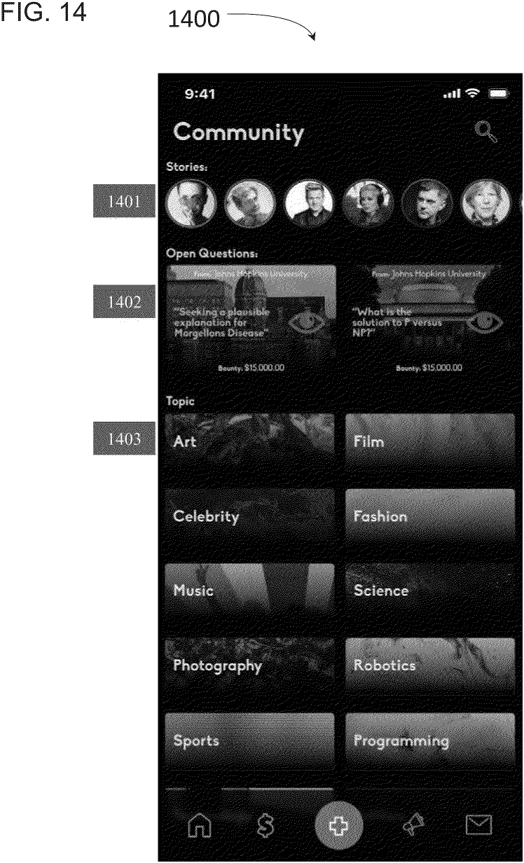

FIG. 8 shows an exemplary Individual Chat interface 800 within a Chat thread. Buyers can exchange messages with both Buyers and Sellers individually between each other and in groups. The Chat Overview interface is shown in FIG. 15.

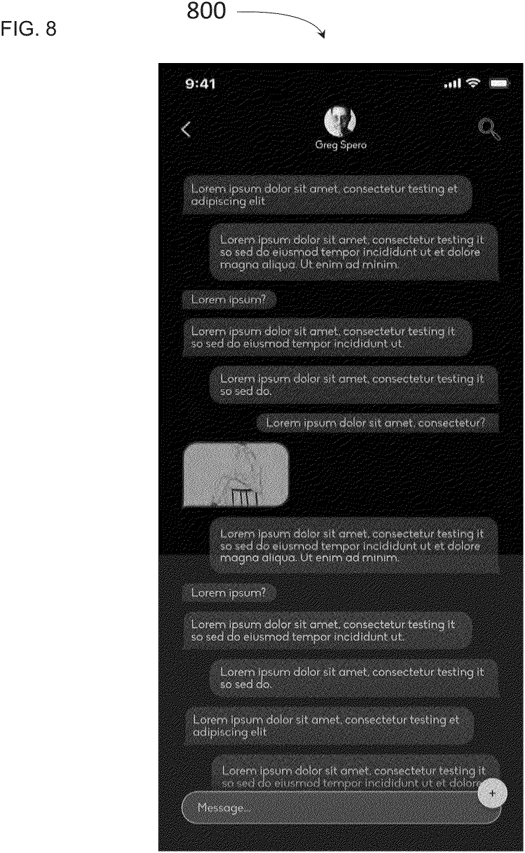

FIG. 9 shows an exemplary Payments interface 900 where Buyers can add a credit card to their account. Once a credit card is added, Buyers can make payments in $5 increments. The funds entered into the Buyer’s account can be used in increments as low as $0.30 to bid on Seller questions. Block chained based tokens may also be used as currency.

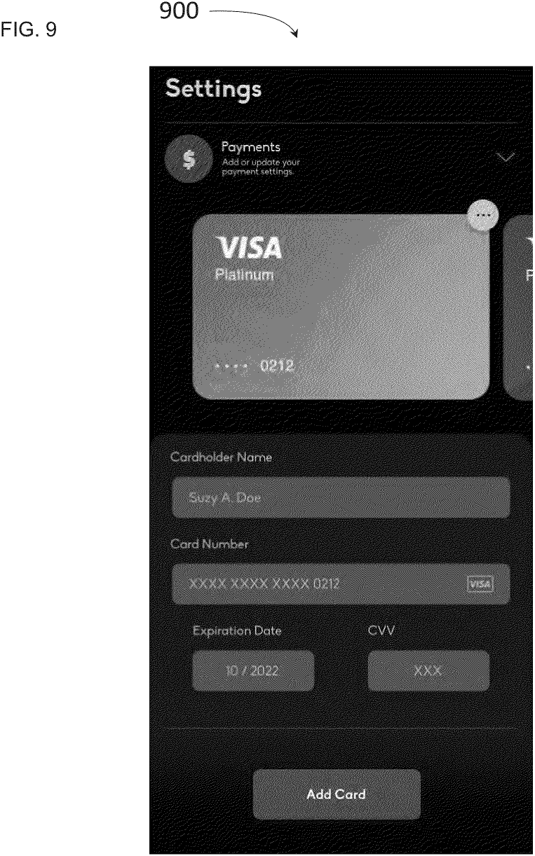

FIG. 10 shows an exemplary Answer Card 1000 in horizontal view for the answer that consists mainly of video content. All Buyers and Sellers in will be able to see all Answers from Sellers, including the Answers in video format.

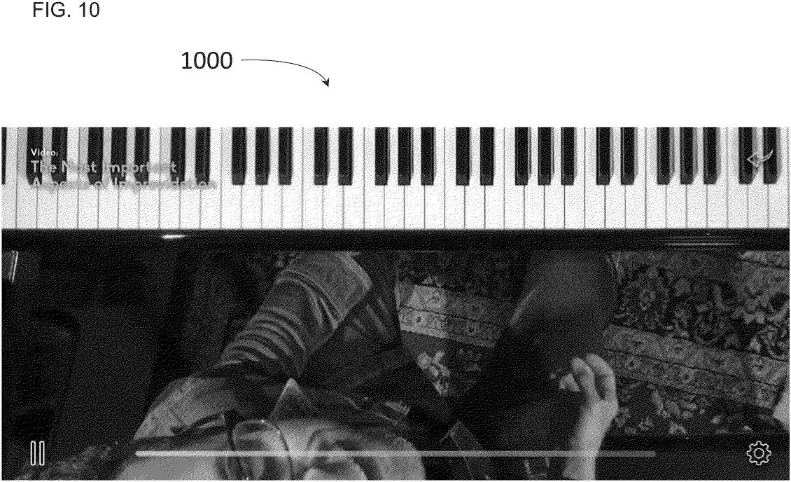

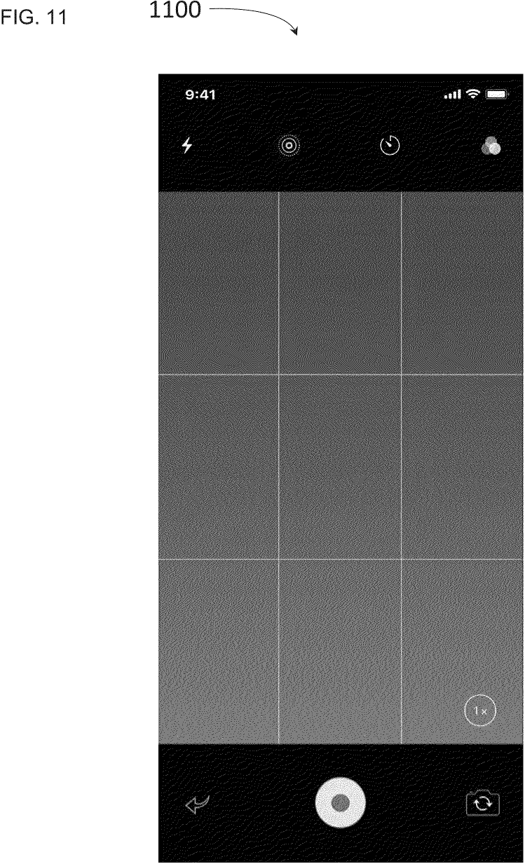

FIG. 11 represents an exemplary camera interface 1100 with which Buyers and Sellers can take their Profile Pic. The Profile Pic can be taken from this interface 1100, or uploaded as a pre-existing image file. The Profile Pic will be displayed on the top of the user’s profile page (see FIG. 12) and in other places where the Buyer or Seller’s profile image is used, e.g., 507 and 601.

FIG. 12 shows an exemplary Buyer profile interface 1200. This interface 1200 is publicly viewable by both buyers and sellers, and includes the following information
Profile image, name, and location of Buyer 1201
Bids (Active and Closed): a list of Questions on which the Buyer has active Bids, and a list of Answers on which the user has Bid before the Question was answered, 1202 far left
Questions: A list of questions that the Buyer has submitted to Sellers, 1202 middle
Likes: A list of Questions and Answers that the user has Liked, 1202 right.
Settings link, 1203.

FIG. 13 shows an exemplary Seller Profile 1300. This is the page that includes relevant information about the Seller, and is publicly viewable to all Buyers and Sellers in the system. It includes the following information:
Seller profile image, name, and location 1301
Message button 1304. When clicked, this button will take you to the chat interface in which the user viewing the Seller page can send a direct message to the Seller in question.
Follow button 1303. When the user viewing the page is already following the Seller in question, the Follow button will say “Following”. When the user viewing the page is not yet following the Seller in question, the Follow button will say “Follow” as a call to action.

Questions, 1302 left: This will trigger the appearance of a list of Bid Cards for the questions that have been asked of the Seller in question. It will also display statistics including Total Current $ Bid and Total Number of Questions asked to the Seller.

Answers, 1302 middle: This will trigger the appearance of a list of Answer Cards for the Answers that have been submitted to Questions asked of the Seller in question. It will also trigger the display of statistics including the Total Amount Earned and Total Questions Answered by the Seller.

About, 1302 right: This will trigger the appearance of a page that includes information such as biography, photos, and other relevant information about the Seller.

Seller, which also can be referred to as a Creator, e.g., execution of an Idea submitted by a Buyer, can also view Buyers in order of outstanding bids (highest to lowest), executed bids (highest to lowest), location of Buyers, demographic information from Buyers, including sex, age, and income as well as other pertinent information.

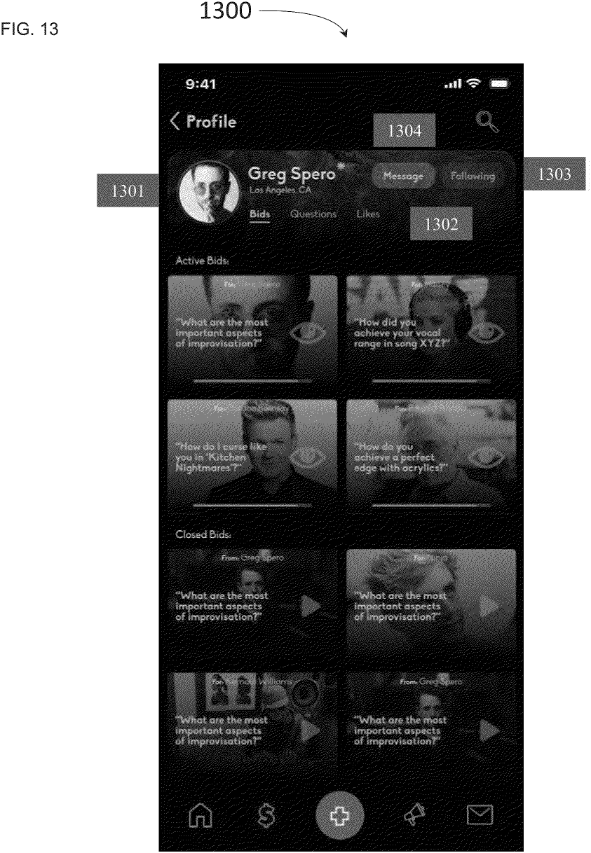

FIG. 14 shows an exemplary Community Page interface 1400. This page 1400 represents the categorization of Questions and Answers into subject-based sections. It also displays relevant current social information uploaded by users. The top of the Community Page interface 1400 includes of a list of Stories uploaded by Users 1401. Users can upload Stories which may include video and text limited to short clips (up to 10 seconds each approximately in a preferred embodiment). These Stories 1401 appear to other users when their profile image is clicked. Users will be able to see that a story is available from another user when a highlighted circle appears around the user’s Profile Pic. Users will be able to Go Live in their Story 1401 for an unlimited amount of time. When a user is broadcasting live to their story, a red dot will appear in the middle of the story representing that the user is currently broadcasting live. Below the User Stories will be a list of Open Questions, scrollable horizontally 1402. These questions will refresh every 1 or 2 seconds with the new most relevant question at that moment. Below the Open Questions will be the list of Categories 1403. These categories will be selected by administrators based on the popularity and size of different user-created tags and the number of questions and relevant total sum of bids on questions in a potential category. Buyers will be able to Follow a specific Category 1403 from the Community page 1400. Once a Buyer follows a Category 1403, he/she will be notified when a new question is submitted in that Category 1403, and questions from that Category will be more likely to appear on his/her Home Page 100, FIG. 1.

FIG. 15 represents an exemplary Chat Overview interface 1500. This page will display all of the active chats 1501 in which the user in engaged. Once a user clicks on a chat, the Individual Chat page (FIG. 8) will be activated between the users engaged in that particular chat.

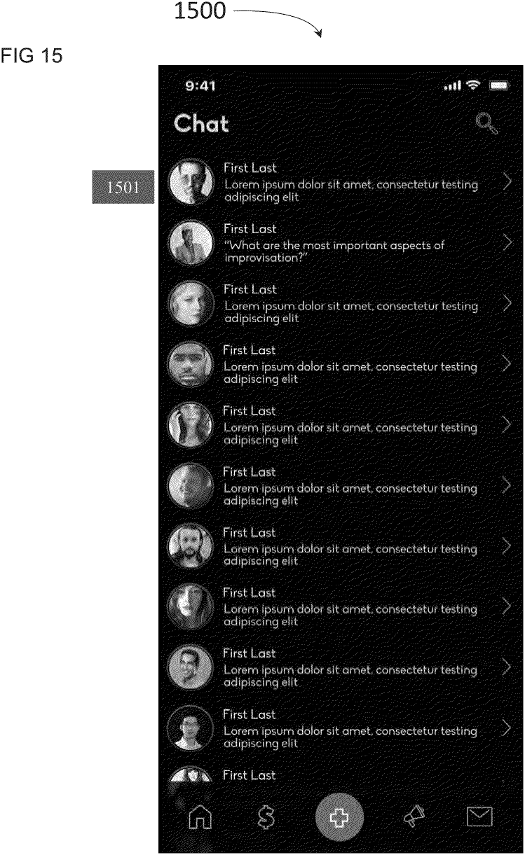

FIG. 16 represents an exemplary Settings section. From this section, users will be able to:
Edit their profile
Adjust privacy settings
Turn notifications on and off
Input payment systems including credit cards, and bank details for receiving payment
Get support for use of the app
Change language
Review the terms of service
Log out

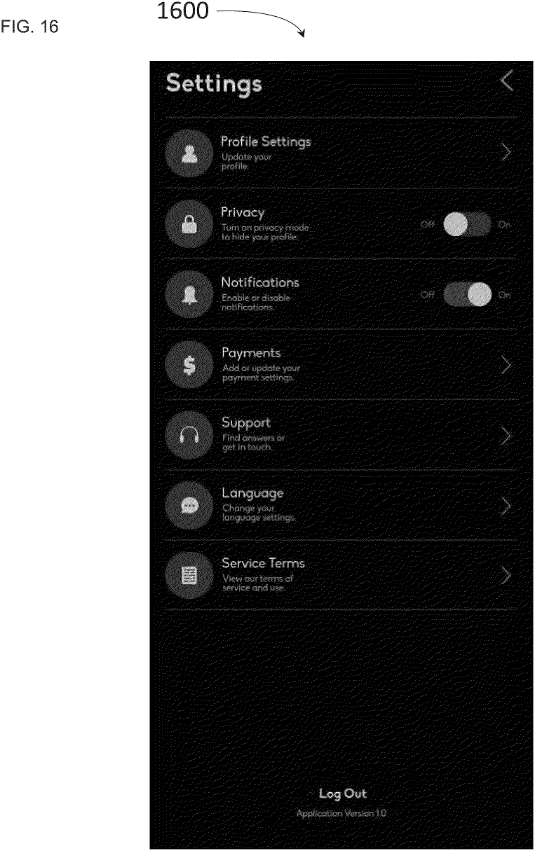

FIG. 17 shows an exemplary interface 1700 in which a Seller can review all questions that he/she has the opportunity to answer. This includes any questions Buyers have asked to that Seller 1701 all displayed in the form of compressed Bid Cards. Seller can click any Bid Card 1701 in this section in order to see the full details of that question, as displayed in FIG. 5. From there, Seller will be able to quickly and easily submit an Answer to the Question, and receive payment from Buyers for the Seller’s Answers.

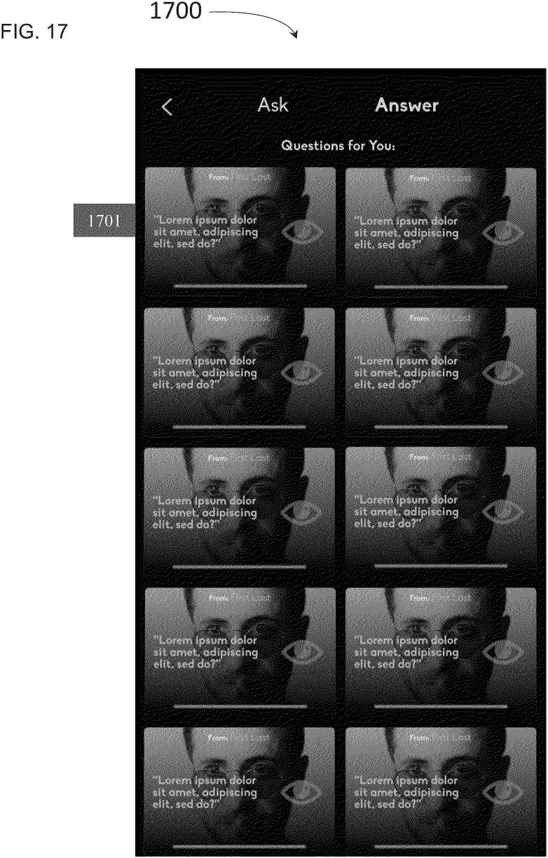

FIG. 18 shows an exemplary Profile Settings interface 1800. On this page 1800, Buyers and Sellers will be able to adjust their own personal information, including Name, Email, Location, and Birth Date. Some information will be publicly available to other users, and some will be held privately within the system for internal use.

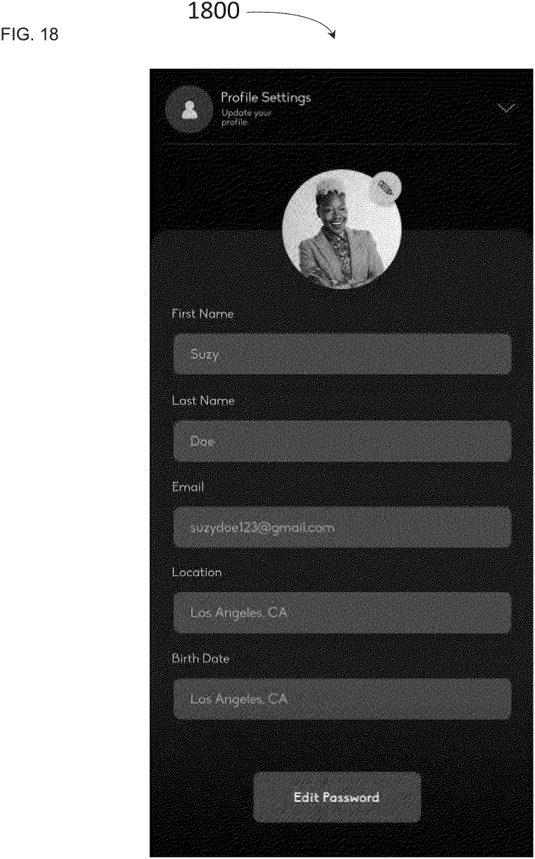

FIG. 19 represents an exemplary Buyer’s Opening Tutorial interface 1900. Buyers will see this simple tutorial upon first logging in to the WeeBID interface. It begins with “Ask Questions, Get Paid” prompt 1901. It also alerts the Buyer that, once a question is answered, the Buyer who originally created the question receives 1.5% of the total payout of that question. This provides extra incentive for Buyers to submit questions to Sellers. For example, if a Buyer asked Kanye West to create a song about socks, and that question’s total bid ended up at $1,000,000, then once Kanye answers the question, the user who created the question receives a payout of $15,000.

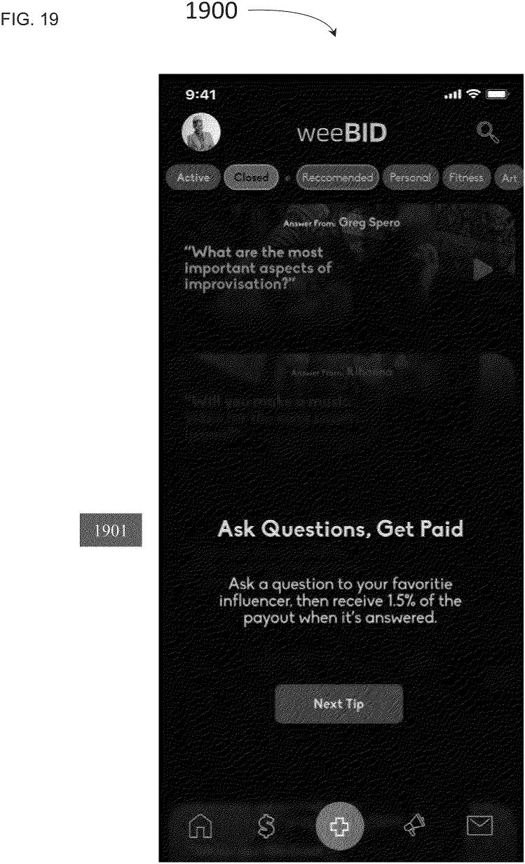

FIG. 20 represents an exemplary General Question Page interface 2000 (GQP). A GQP can be created by an individual, corporation, or non-profit, when they want a question answered, but it could be answered by anyone. People will submit answers to these General Questions, and when a successful answer is submitted, the person who submitted that successful answer receives the full payout for that question. This can be created, for example, when an organization wants to see a cure for a disease. If Johns Hopkins University created a GQP for “Seeking a plausible explanation for Morgellons Disease”, and someone discovered a plausible explanation and submitted it, that explanation would need to be approved by John Hopkins University, and upon approval, the user who submitted the answer would receive the full payout for that GQP (in this case $6,800.00).

If the original organization creating a GQP allows it (via a toggle button when submitting the question), Buyers can also contribute to GQPs in the same way that they can bid on other Buyers’ questions. These additional bids will add to the Gross Expected Payout and will be transferred to the person who successfully answers the question. In this case, the approval of the answer will be controlled proportionally based on the ratio of money offered on an Answer to the GQP. For example, if Johns Hopkins offered $5,000, and other buyers contributed $1000 total, then John Hopkins would have 80% say in approval of the Answer, and the other buyers would collectively have 20% say in the approval of the Answer.

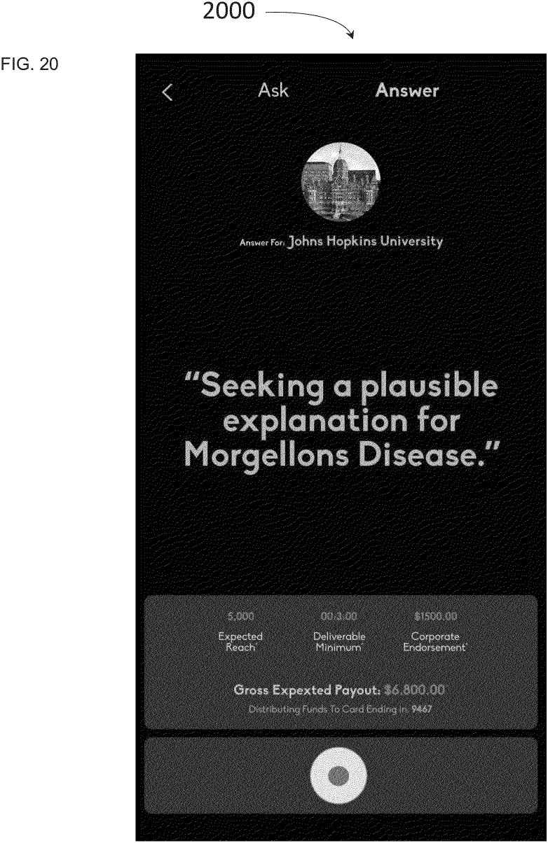

FIG. 21 represents an exemplary screen on which users may be asked to enable push notifications.

Buyers will be notified in the following instances:
A new question has been submitted to a Seller they follow
Another Buyer has added a Bid to a question they submitted
A Seller has answered a question they Bid on
A Seller has answered a question they created
A new question has been posted in a Category they follow

Sellers will receive Notifications in the following instances:
A Buyer bids on a question asked of the Seller
A Buyer submits a new question to the Seller
A question reaches the Goal amount set by the Seller (in which case the Seller will be prompted to answer the question through the answer interface, and taken to the Submit Answer Page (FIG. 5)

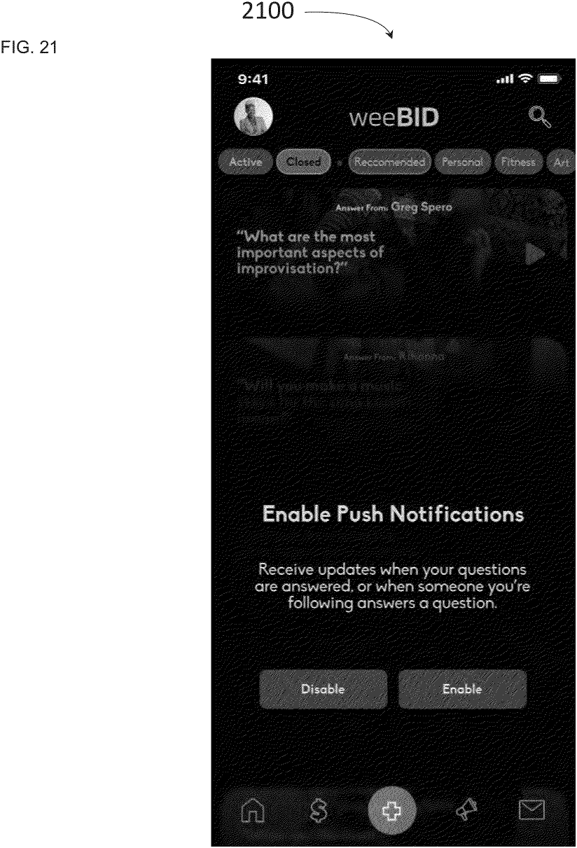

FIG. 22 is an example of the ‘Bid Card’ interface 2200 after the Seller has Confirmed a Goal. To Confirm a Goal, the Seller submits a number for the system to present as the Goal on the Bid Card page 2200 for a particular Question. Once the Seller submits the Goal, the Goal appears on the Bid Card page 2200 at 2201.

The purpose of the Goal is to incentivize Buyers to Bid on the Question. When a Goal is set, Buyers have the following additional reasons to Bid:
Buyers know that the Seller is aware of the Question, and is more likely to be observing the state of the Bid Card than if he/she were not aware of the Question
Buyers have confidence that the Seller is willing to Answer the Question if the total Bid amount rises above the threshold of the Goal

The Comment button 2202 enables the Buyer and the Seller to leave Comments on the Bid Cards. The Save button 2203 allows users to Save Bid Cards that they want to watch. Users will receive notifications when their Saved Bid Cards increase in Total Bid or are Answered.

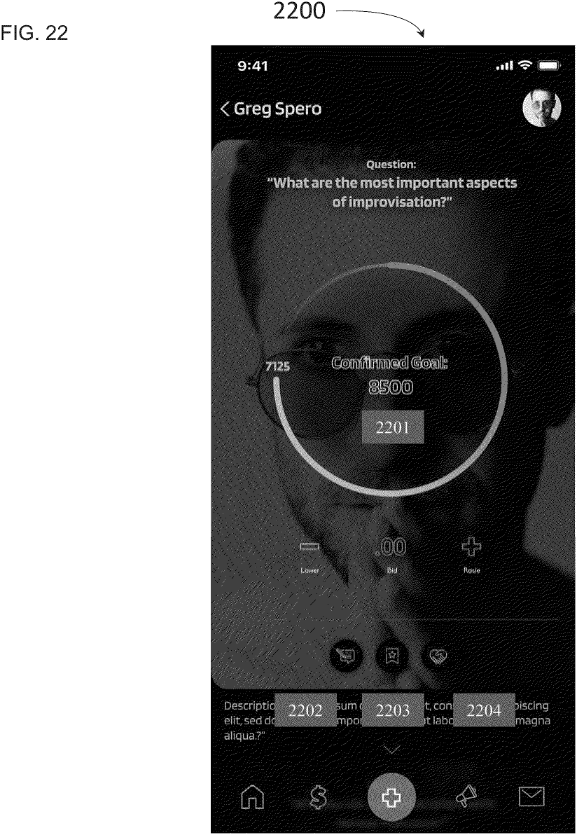

FIG. 23 shows an exemplary Bid Card interface 2300 when it is has not been Claimed by a Seller. When a Buyer submits a Question to a Seller, and the Seller is not already an authenticated Seller on the system, the Seller will have to register and then Claim the Bid Card before he/she can set a Goal and submit an Answer to the Question. A seller can click “Claim this question” 2301 to begin the verification process. Once the Seller has been verified, the Seller can set a Goal and submit an Answer to the Question. The graph on the Bid Card page represents the growth of the Total Bid Amount over time 2302.

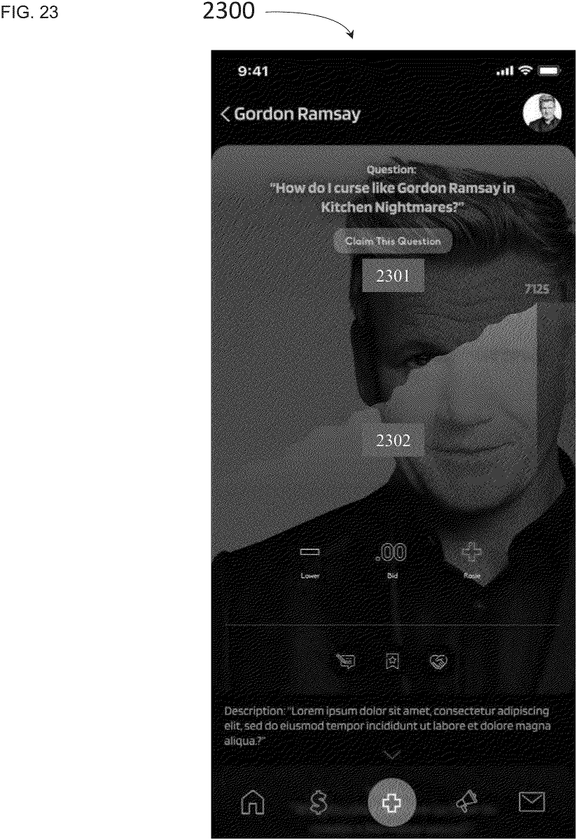

FIG. 24 is an example of a User Profile Page interface 2400 with the Questions Section selected 2401. The ‘Questions Section’ shows Questions that the User has submitted to other Users. The Open Questions 2402, when selected, denotes that all Questions displayed on the page are Open Questions. ‘Open Questions’ means the Question has not yet been Answered, and Buyers can still Bid on the Question. The ‘Closed Questions’ section 2403 shows Questions that the User in the current profile has submitted to other Users, which have been successfully Answered.

Any user can be a Buyer, or a Seller, or both simultaneously within the same account. Buyers and Sellers share the same Profile page with some differences:
When a user clicks on a Seller Profile, that Seller’s first page to display is the Asked section, showing Open Questions that are Asked to that Seller.
When a user clicks a Buyer Profile, that Buyer’s first page to display is the “Questions” section, showing the Questions submitted to other Users on the platform that have originated from that Buyer.

When a user has successfully submitted an Answer to a Question, they will be considered a Seller primarily, though they can also remain a Buyer. When a user has submitted Bids or Questions but has not Answered a Question, that user will be considered a Buyer primarily, but can always become a Seller by answering a Question that is posed to him/her.

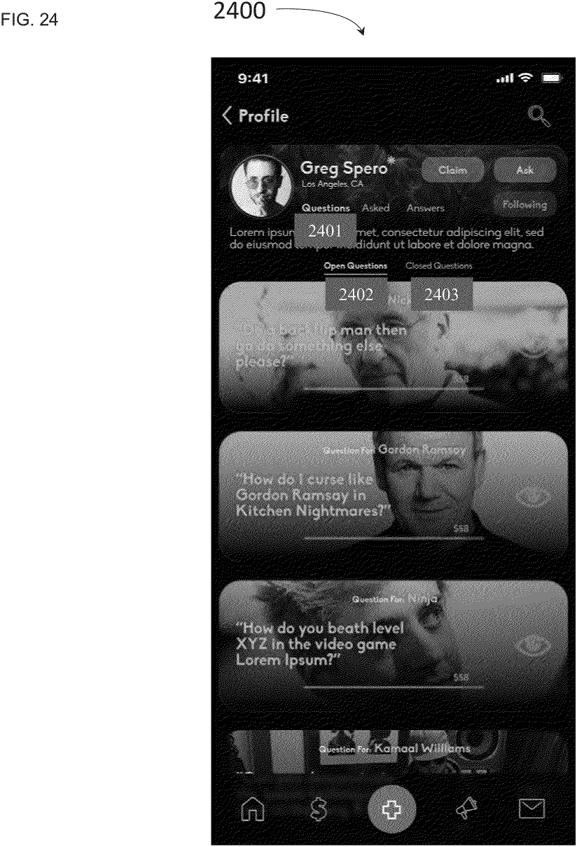

FIG. 25 shows an example of a User Profile Page 2500 when the ‘Asked’ section 2501 is selected. The ‘Asked’ section denotes Questions that have been Asked to the User in the current User Profile Page which have not yet been successfully Answered. The Questions with the highest Collective Bids will display at the top of this section, creating a destination for Users to go when they want to see the most pressing Questions from the crowd to a particular Seller.

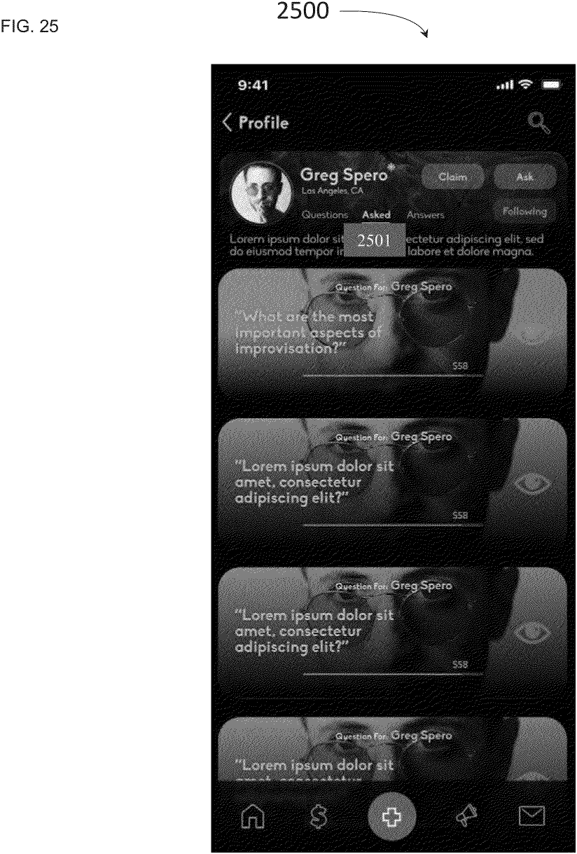

FIG. 26 is an example of a User Profile Page 2600 when the ‘Answered’ section 2601 is selected. The Answers page displays Closed Bid Cards that represent the Answers to Questions that have been made to the User in the current User Profile Page 2600. Answers will be displayed in order from top to bottom based on multiple variables including the number of total Saves and Loves the Answer has received from Users, the Total Bid the question received upon its execution, average percentage of Answer viewed by any given User who watches the Answer, and other metrics pointing to the relevance of the Answer.

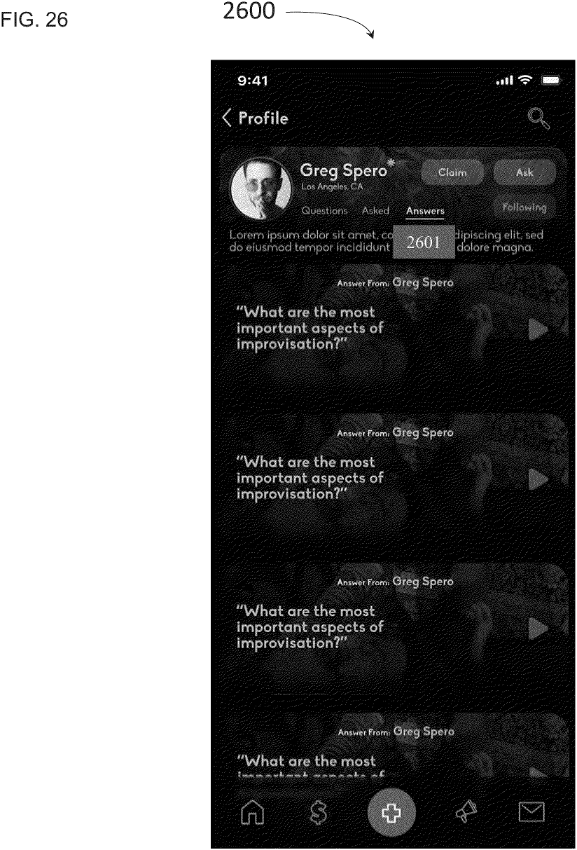

FIG. 27 is an example of the page a Seller sees after he/she has submitted an Answer and selected the “Donate” button 2701. The Donate button is a button that that the Seller can select which does the following:
Notifies all Buyers who Bid on the Question that all proceeds from the Answer will go to a specific Charity
Adds a badge on the Bid Card that marks that Question as a Donated question, promising the proceeds to a charity.
Locks the proceeds from that question as designated to charity, and notifies the Seller that they will not be able to undo the designation of those proceeds to charity.

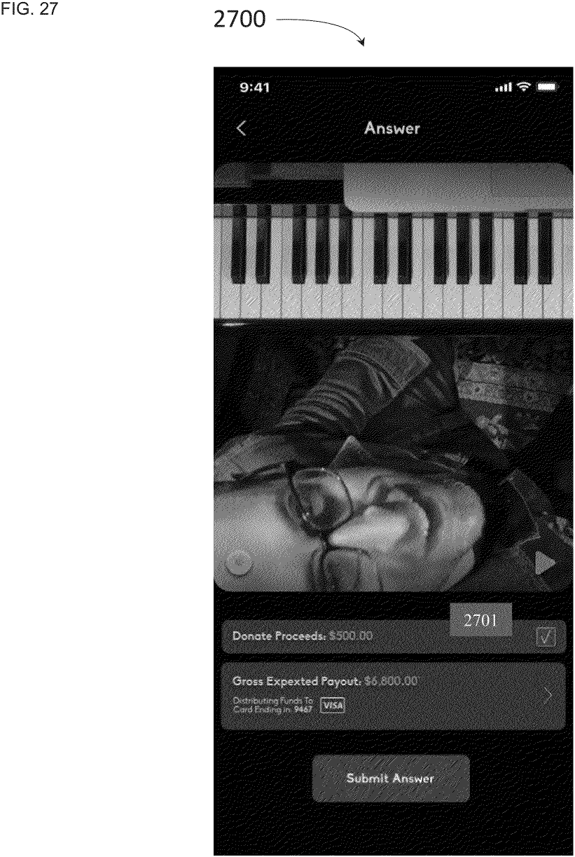

FIG. 28 is an exemplary flow diagram 2800 that describes the process that occurs when a buyer asks a question, and that buyer and other buyers bid on a question, resulting in a Bid Card that has accrued value The process 2800 starts at 2805, where Buyer creates a question for a Seller. That question is then made available to other users, including the original user to Bid on (action blocks 2810 and 2815 and 2820). The total bids are tallied 2830 and then a Bid Card is created with total bid (action block 2835).

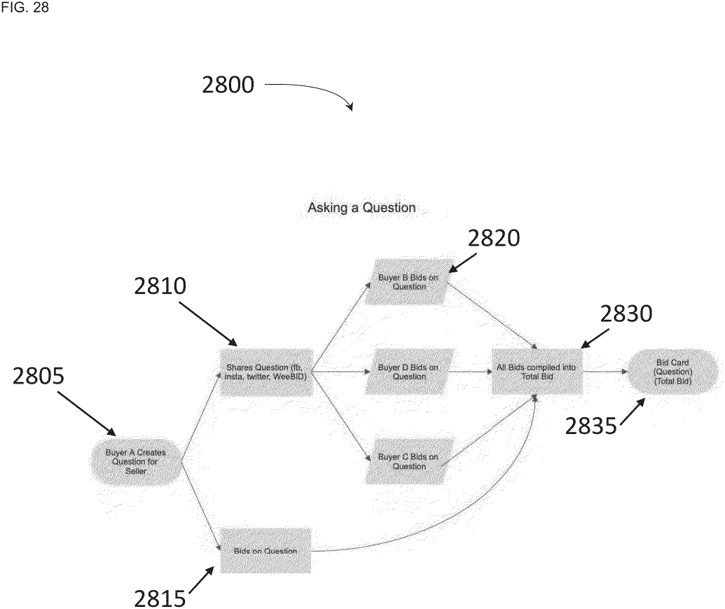

FIG. 29 is an exemplary flow diagram 2900 that describes the process a Seller takes when answering a question. It starts with a Bid Card that has accrued enough value to be enticing to the seller (starting block 2905). The seller receives a notification (action block 2910), and submits an answer (action block 2915). The answer goes through the buyer verification process (action blocks 2920 and 2930), and if it is accepted (decision block 2940), the exchange between the Buyer and Seller is executed (action blocks 2945, 2950, 2955 and 2960). This process enables the crowd to judge the question to assure that it is at an adequate level of satisfaction to the crowd before the transaction is finalized.

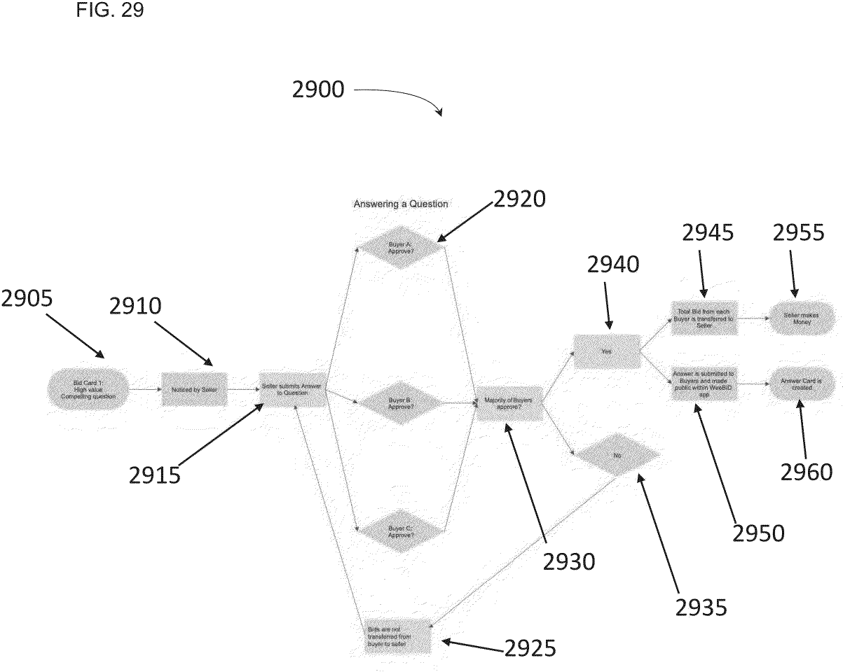

FIG. 30 is an exemplary flow diagram 3000 that describes how Bid Cards increase in value based on interactions within the community of Buyers and Sellers and media. Depending on the questions therein, Bid Cards are shared by both Buyers and media outlets, resulting in more Buyers adding Bids to the Bid Cards, increasing the Bid Card’s value.

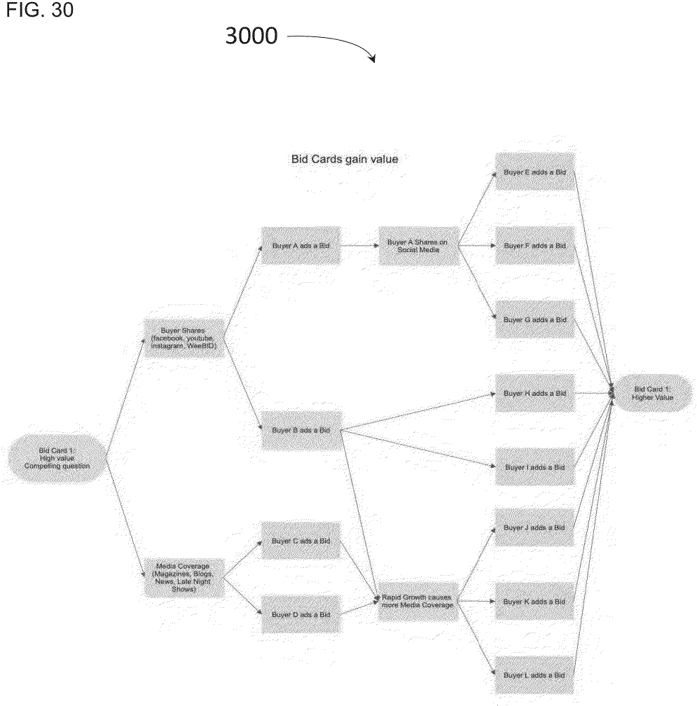

FIG. 31 is an exemplary flow diagram 3100 that describes how interactions within the present system create viral growth for both the Buyer and Seller community, and the content they create.

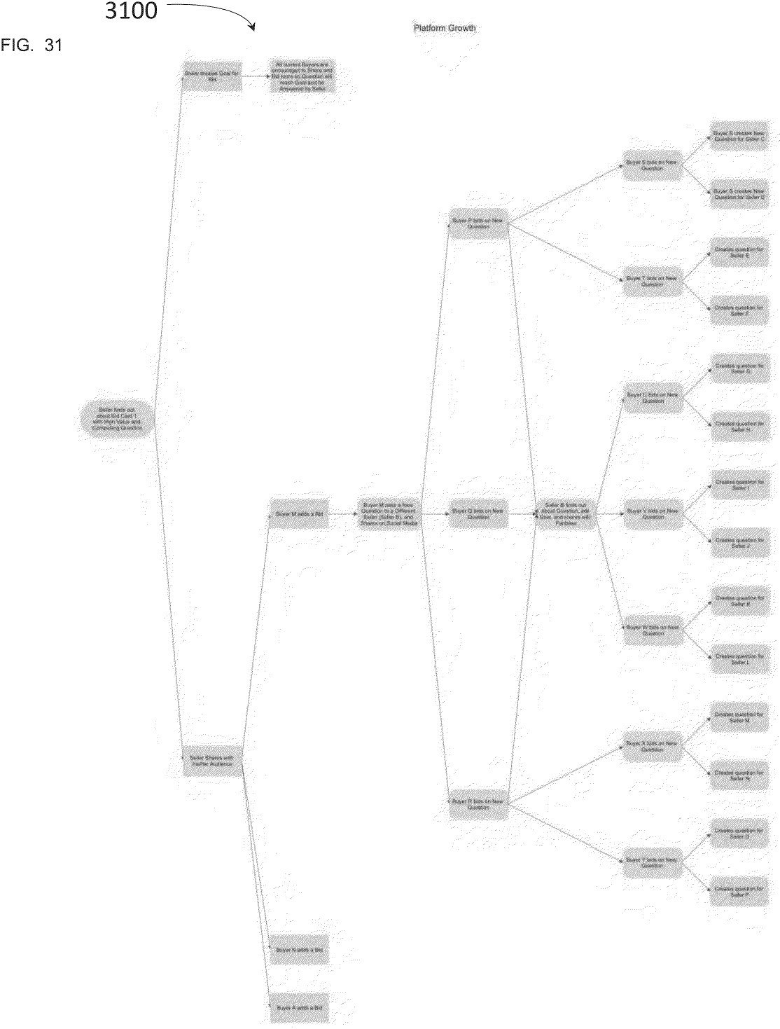

FIG. 32 is an exemplary flow diagram 3200 that describes the interactions between the human component (Buyers and Sellers), the app itself, and the server that stores the data used by the app. The app facilitates the exchange of money and information between Buyers and Sellers.

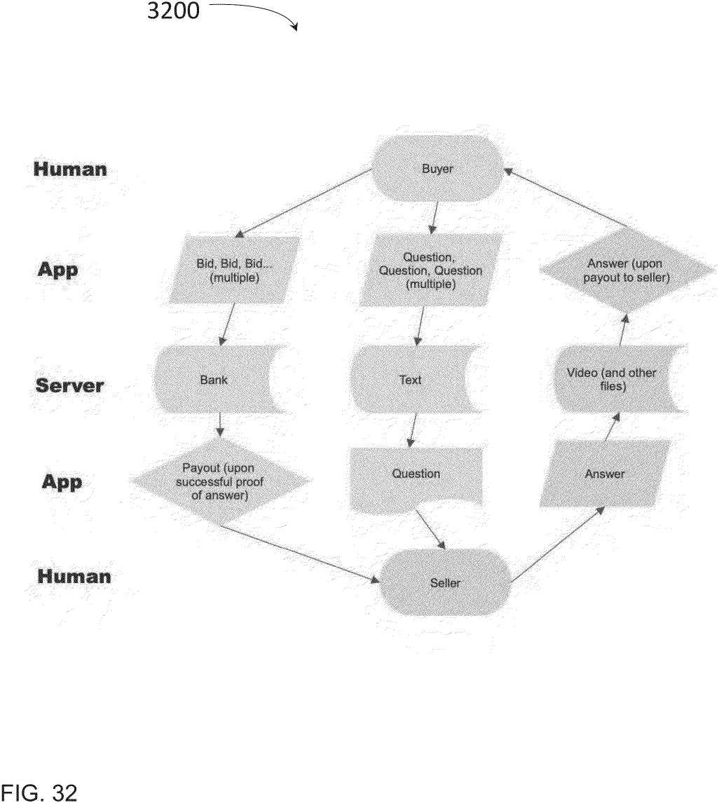

FIG. 33 is an exemplary flow diagram that outlines the user experience of entering the app, and navigating through its basic functionality. It also outlines the basic database processes that occur upon sign up.

FIG. 34 is an exemplary technical figure 3400 that describes the interaction between the database DB located at server system 12, application on user device 14/15, and the user when creating an account. The database is a database system known in the art and is part of a backend system 12 located remotely from the portion of the Application located on the user’s device 14/15, and accessible over a network. The server system 12 reconciles the multiple users and server based functions.

FIG. 35 is an exemplary technical figure 3500 that describes the interaction between the database, application, and the user when submitting a question. It is noted that submitting a question can also include submitting Ideas for a seller to execute such as product ideas or other ideas beyond informational answers. An Idea can create equity. For example, a reply/answer to Idea or Question can create a digital asset minted as a non-fungible token (“NFT”). Revenues generated from these assets will be assigned to be paid to the rights-holders of a respective NFT. Funds can be distributed in proportion to their financial contribution as compared to total Bid.

The generator of the question can delete the questions/ideas they pose to a seller/creator at any point until a bid is posed as described above.

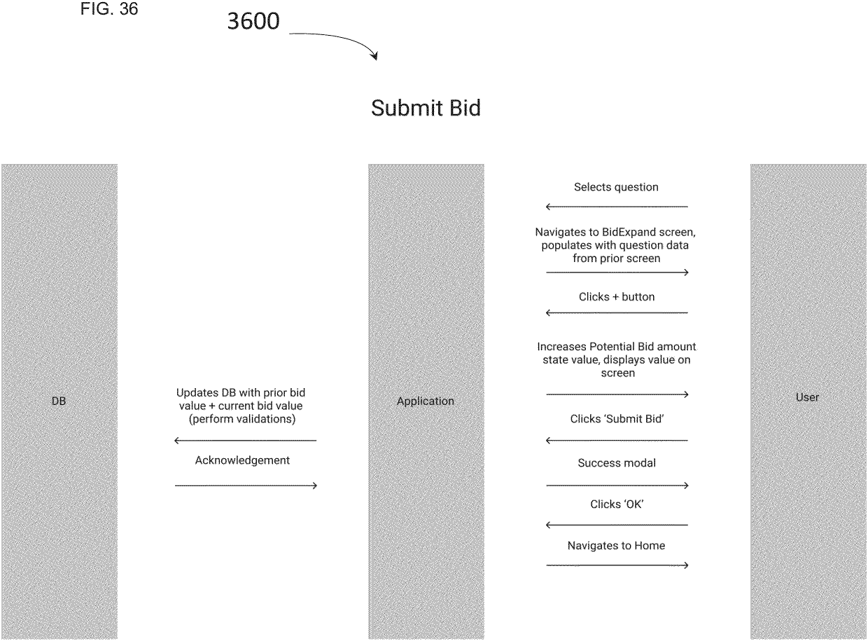

FIG. 36 is an exemplary technical figure 3600 that describes the interaction between the database, application, and the user when submitting a Bid.

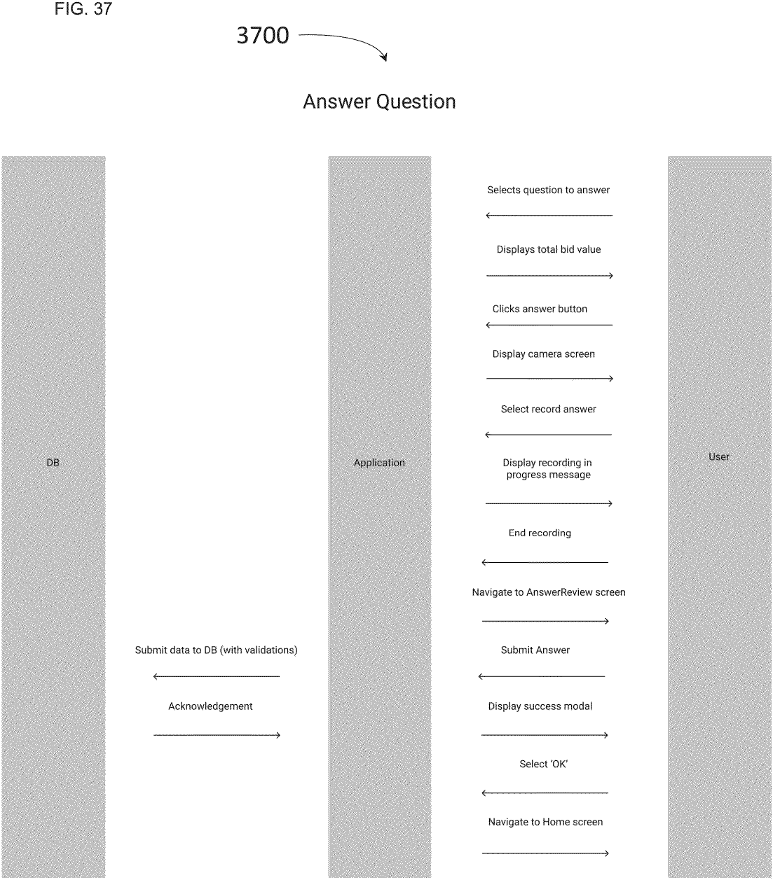

FIG. 37 is an exemplary technical figure 3700 that describes the interaction between the database, application, and the user when submitting an Answer to a Question. Said Answer may include a video response or a link to a source confirming completion of Answer or execution of Idea.

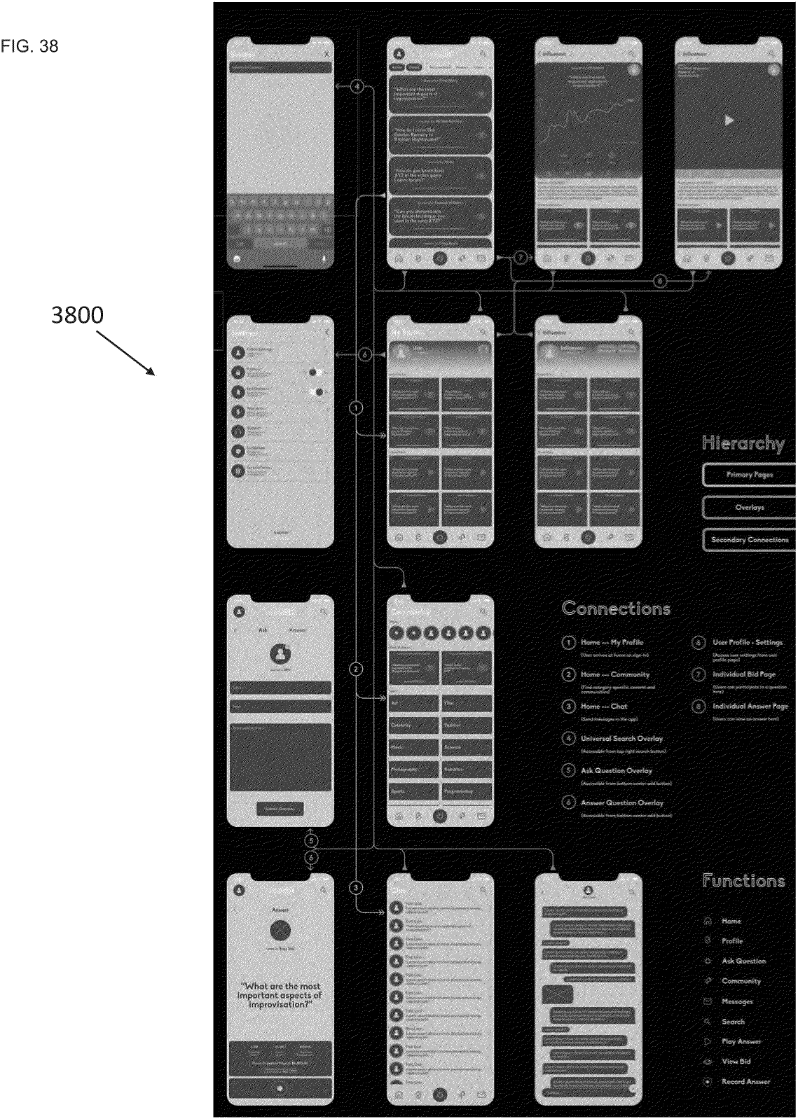

FIG. 38 is an exemplary technical figure 3800 that describes the user flow between the primary aspects of the user interface.

### System Architecture

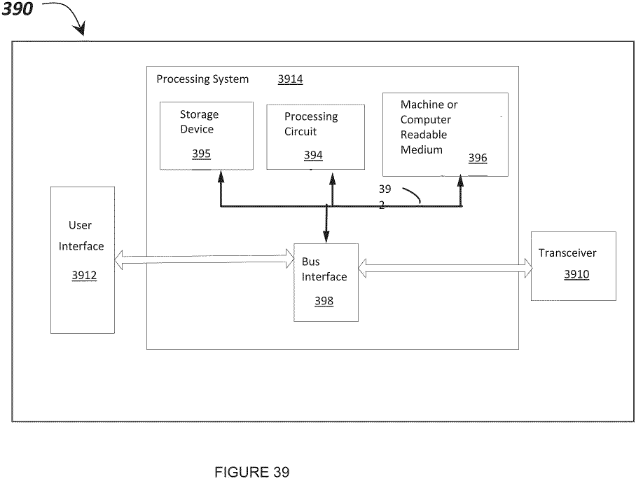

FIG. 39 illustrates an exemplary overall platform 390 in which various embodiments and process steps disclosed herein can be implemented. In accordance with various aspects of the disclosure, a device, component or element, or any portion of a device, component or element, or any combination of devices, components or elements may be implemented with a processing system 3914 that includes one or more processing circuits 394. Processing circuits 394 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 394 may be used to implement any one or more of the various embodiments, systems, algorithms, and processes described above. In some embodiments, the processing system 3914 may be implemented in a server. The server may be local or remote, for example in a cloud architecture.

In the example of FIG. 39, the processing system 3914 may be implemented with a bus architecture, represented generally by the bus 392. The bus 392 may include any number of interconnecting buses and bridges depending on the specific application of the processing system 3914 and the overall design constraints. The bus 392 may link various circuits including one or more processing circuits (represented generally by the processing circuit 394), the storage device 395, and a machine-readable, processor-readable, processing circuit-readable or computer-readable media (represented generally by a non-transitory machine-readable medium 396). The bus 392 may also link various other circuits such as timing sources, peripherals, voltage regulators, and power management circuits, which are well known in the art, and therefore, will not be described any further. The bus interface 398 may provide an interface between bus 392 and a transceiver 3910. The transceiver 3910 may provide a means for communicating with various other apparatus over a transmission medium. Depending upon the nature of the apparatus, a user interface 3912 (e.g., keypad, display, speaker, microphone, touchscreen, motion sensor) may also be provided.

The processing circuit 394 may be responsible for managing the bus 392 and for general processing, including the execution of software stored on the machine-readable medium 396. The software, when executed by processing circuit 394, causes processing system 3914 to perform the various functions described herein for any apparatus. Machine-readable medium 396 may also be used for storing data that is manipulated by processing circuit 394 when executing software.

One or more processing circuits 394 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The invention described herein facilitates the creation of multiple marketplaces that are not yet in existence. The following are examples of a few of marketplaces that may be created:

### Movie Industry

The present system provides a platform on which a Buyer can submit an idea for a movie directly to the individual or company (producer or studio) that would create the movie. Other Buyers can bid on that idea, and the movie can become funded based solely on the demand that exists in the marketplace before the producer or studio takes any initiative to plan for the movie, raise funds for the movie, or propose the movie to a major movie studio that could finance it. This leaves a space for the creation of a marketplace of an infinite number of movie ideas, and the most in-demand ideas are most likely to raise the most funds and become financed to the Point Of Creation. The Point Of Creation would be the tipping point in terms of total Bid dollars offered by the collective Buyers that would make it worthwhile for a Seller to create the movie that the Buyers have requested in their Bid.

### Documentaries

Documentaries are often produced with a motive to convince the public of a story. The most valuable documentaries to mankind are the ones created not with the entertainment of the public in mind, but with the explanation of a reality in mind that often does not align with popular opinions. These documentaries are the hardest to finance, and they are also the least likely to be created because the people who have the deepest knowledge are usually not the people who have the motivation to create something to entertain the public. The minority of people who are interested and insightful enough to consume information from a real expert are also more inclined to feel strongly that the expert should have the means and motivation to create a platform for his/her specific insights to reach the general public. The present system will allow these interested people to submit Questions to industry experts requesting that they create Documentaries or other forms of media output that bring their unique insights to the public on a larger scale. It will allow other Buyers to support those Questions even before the Seller is willing to consider creating the Documentary, until the Bid is at a high enough level to make it worthwhile for the Seller to accept and create the Documentary about the subj ect that Buyers want to see brought to light to the public.

### Leadership

The best leaders are not always the people who want the position of leadership. The present system will facilitate the fund raising of candidates for leadership positions even if the person being nominated has never expressed interest in that position. The more the funding, the easier may be to get the candidate interested since campaign fund raising could be an important stumbling block in any campaign. For example, if a Buyer is a fan of “Leader A,” and admires his philosophical viewpoints and business acumen so much that he thinks Leader A should be president of the United States, the Buyer could create a Question saying “Leader A, run for president of the United States.” Other Buyers could bid on that Question, and the Bid could get high enough to do two things: 1) Convince Leader A that there is a very high demand for him to run for president, and 2) Create a campaign fund in advance of Leader A running for president, in the form of a Bid, which would be transferred directly to Leader A as soon as he officially joins the race for President.

### Concerts

Artists are often searching to find out what their fanbase wants to hear. This question spans to subjects such as “Who do my fans want to see me collaborate with” to “what songs would my fans want me to cover” to “what cities should I play in” and more. By allowing fans of artists to submit any Question to that artist, and allowing them to Bid on the Questions, the present system platform will be able to answer this question for any artist whose fans use the system. If a fan wants to see the Artist perform in Chicago, he/she can make a Question that says “Artist A, perform in Chicago” and bid $10. Then if 1000 other fans bid $10 for that artist to come to Chicago, the artist will have $10,000 of funds already allocated towards a tour to Chicago if the artist does agree to perform there.

### Recorded Music

Additionally, a fan of Artist A can submit a question saying “Artist A, make a song with Artist B”. If a million fans between Artist A and Artist B bid $1 on the creation of the collaborative song, then $1,000,000 will be waiting to be claimed by Artist A once he/she delivers a song with Artist B.

### Books

The most common current model for book publishing includes the following steps:
(1) Author approaches publisher with an idea.
(2) Publisher agrees to that idea and gives advance to the Author
(3) Publisher receives book from Author, distributes the book, and collects the majority of the profits from sales of the book.

The present system has the opportunity to disintermediate the book publishing market, by giving knowledge and control of book curation and publishing to the Author of the book. For example, a buyer in can create a question to J.K. Rowling that says “J.K. Rowling, write a sequel to Harry Potter and the Deadly Hollows.” An estimated 18% of Americans have read all 7 of the Harry Potter novels. If those 57,240 ,000 Americans each bid $1 on that question, then J.K. Rowling would have $57,240,000 to self-fund the book, and direct communication with everyone who would purchase the book after it is curated. It removes the need for the publisher and distributor from the equation and allows J.K. Rowling’s fanbase to communicate directly with her.

### Food

McDonald’s and Starbucks are constantly testing new foods in different markets to gauge what consumers want. Using the present system, Buyers will be able to submit an unlimited amount of ideas for new foods (in the form of Questions) to McDonald’s, Starbucks, and other restaurant chains and food manufacturers. Buyers will be able to see each other’s Questions, and bid on the Questions that are most compelling to each of them. The most compelling food ideas will rise to the top of the hierarchy of Bids by Bid amount, and the food chains will be able to see the most in-demand requests for new foods. Additionally, they will have guaranteed income from providing a specific new food product, because once they start providing the food product, the Question that outlined the request for that food product would be considered Delivered, and the Bids from all Buyers who Bid on the Question would go directly to the food chain providing the new food.

For example, a Buyer could ask the Question “McDonald’s, provide a Keto friendly breakfast sandwich all day everywhere in the US.” If 5 million people each bid $5 on that Question, then McDonald’s would have $25,000,000 waiting for it which would be delivered as soon as they launch the Keto friendly breakfast sandwich nationally in the US.

### Education

Some of the best professors’ lectures have very limited reach. If students, or universities themselves, want to see the lectures of a specific educator made public, one of them could create the Question “Educator A, record all your lectures for your classes this year and make them public.” Upon recording and releasing his/her lectures, Educator A would receive the full Bid amount that Buyers placed on the Question.

### A Bounty for Reformed Viable System of Human Capability

One of the present system’s functionalities is the ability to create a Bounty on a question without directing it towards a specific Seller. This functionality has the power to solve maj or world problems for business and government. One example of this power could be seen in the need for businesses to have a uniform unbiased system of judging candidates that come from any school or online educational platform. For example, one business creates a Bounty with the question “Create a reliable system of judging a candidate for a job regardless of what school, online education, or experience they’ve been through.” The bounty would include more thorough details than normal Questions, and would give the Company submitting the Bounty the opportunity to thoroughly describe what it wants to see created. The company could bid $500,000 on this system, because it would be so valuable for hiring. Then 10 other Companies could each bid $500,000 on the curation of this system, making a $5,000,000 bounty available to the group that facilitates the curation of this system. At that point, it becomes worthwhile for a tech company to invest $1,000,000 of their own money into the creation of this system, because if they successfully execute it, they will get the $5,000,000, and even if they don’t get the $5,000,000, they see that there is a demand in the marketplace equivalent to at least the $5,000,000 that has been bid on finding a solution to the problem.

### Investing

If an investor wants to make an investment in a specific market, into an application that has certain functionality with specific parameters, the investor can outline that idea, and upload it as a Bounty. For example, an investor can create a bounty that says “I will invest $100,000 into a telecom company that does not have the excess baggage of in-store locations, has contracts with cell tower companies that facilitate nationwide coverage, and has the 5 major C-level positions filled with capable people,” That investor would receive proposals from companies who believe they match that criteria, and once a company makes a proposal that matches the criteria to the investor’s satisfaction, the investor would accept the company’s proposal, and invest the $100,000 in the company.

### Server and Database Structure

The server system 12 will house all the data relevant to the system 10. Servers 12 are built upon a system like AWS or Google Cloud Server.

### Database Information

### Firebase Firestore (NoSQL)

Database collection (folders), documents (files), and attributes: The following list represents the different types of data that will be stored in the WeeBID database.
users collection
bids subcollection
   bid amount
   bid_date_time
   content
   influencer_first_name
   influencer_last_name
   influencer_uid
   question_id
followers subcollection
   follower_first_name
   follower_last_name
   follower_uid
following subcollection
   influencer_first _name
   influencer_last_name
   influencer_uid
likes subcollection
   date_time_liked
   influencer_first_name
   influencer_last_name
   influencer_uid
   question_content
   question_id
questions_for subcollection
   answered (boolean)
   bid_value
   date_time_asked
   date_time answered
   get answer (link to video in cloud storage)
   influencer_UID
   influencer_first_name
   influencer_last_name
   question_asked_by
   question_asked_by_first name
   question_asked _by_last_name
   question_content
   question_id
questions_from subcollection
   answered (boolean)
   bid_value
   date_time_answered
   date_time_asked
   get answer (link to video in cloud storage)
   influencer_UID
   influencer_first _name
   influencer_last_name
   question_asked_by
   question_asked_by_first_name
   question_asked_by_last_name
   question_content
   question_id
   topic
account_balance
email
first_name
last_name
uid
username
profile_picture (link to photo in Cloud Storage)

questions collection
   bids subcollection
      bid amount
      bid_date_time
      bidder_first_name
      bidder_last_name
      bidder_uid
   likes subcollection
      date_time_liked
      user_first _name
      user_last_name
      user_uid
   answered (boolean)
   bid_value
   content
   date_time_answered
   get_answer
   influencer_uid
   influencer_first _name
   influencer_last_name
   question_asked_by
   question_asked_by_first name
   question_asked_by_lastname
   timestamp
   topic

Throughout this disclosure, the preferred embodiment and examples illustrated should be considered as exemplars, rather than as limitations on the present inventive subject matter, which includes many inventions. As used herein, the term “inventive subject matter,” “system,” “device,” “apparatus,” “method,” “present system,” “present device,” “present apparatus” or “present method” refers to any and all of the embodiments described herein, and any equivalents.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

When an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the inventive subject matter. As used herein, the term “and/or” includes any and all combinations of one or more of the associated list items.

The terminology used herein is for the purpose of describing particular embodiments only and is not intended to be limiting. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments are described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the inventive subject matter.

The foregoing is intended to cover all modifications, equivalents and alternative constructions falling within the spirit and scope of the invention as expressed in the appended claims, wherein no portion of the disclosure is intended, expressly or implicitly, to be dedicated to the public domain if not set forth in the claims. Furthermore, any features, functions, steps, or elements of the embodiments may be recited in or added to the claims, as well as negative limitations that define the inventive scope of the claims by features, functions, steps, or elements that are not within that scope.

What is claimed is:

1. An online computing system for crowdfunding and crowdsourcing requests and responses comprising:
a server system coupled to a network;
a first user device communicatively coupled to the server system via the network, said first user device including an application configured to:
enable a buyer to generate a request to a seller and a monetary bid for a response to said request, wherein the server system is configured to enable multiple buyers to generate monetary bids collectively for said request;
a second user device communicatively coupled to the server system via the network, said second user device including an application configured to:
enable a seller to receive said request and collective monetary bids and generate an response in exchange for said collective bids.

2. The online system of claim 1, wherein said request includes request for a text based response, intellectual property response, or real property response.
